(19) United States
(12) Patent Application Publication
(10) Pub. No.: US 2026/0277061 A1
(43) Pub. Date: Sep. 17, 2026

(54) DISPLAY DEVICE AND DRIVING METHOD THEREFOR, AND DISPLAY APPARATUS

(71) Applicants: Chongqing BOE Smart Electronics System Co.,Ltd., Chongqing (CN); BOE Technology Group Co., Ltd., Beijing (CN); Beijing BOE Technology Development Co., Ltd., Beijing (CN)

(72) Inventors: Jingyong HU, Beijing (CN); Junsheng CHEN, Beijing (CN); Lichun CHEN, Beijing (CN); Ganggui SHI, Beijing (CN); Rui HUANG, Beijing (CN); Yichi ZHANG, Beijing (CN)

(21) Appl. No.: 19/168,827

(22) PCT Filed: Sep. 28, 2023
(86) PCT No.: PCT/CN2023/122723

§ 371 Date: Sep. 25, 2025

(51) Int. Cl. G02F 1/1347; G02F 1/1333; G02F 1/1335; G02F 1/1343; G02F 1/1362; G02F 1/137

(52) U.S. Cl. CPC G02F 1/13478; G02F 1/133377; G02F 1/133512; G02F 1/134345; G02F 1/13439; G02F 1/136286; G02F 1/13718; G02F 2203/02; G02F 2203/06

(57) ABSTRACT

A display device includes: a light absorption layer and a liquid crystal element layer, the liquid crystal element layer including at least two stacked liquid crystal elements. Each liquid crystal element includes: a first substrate, a reflective liquid crystal layer and a second substrate. When the reflective liquid crystal layer of one liquid crystal element of the adjacent liquid crystal elements is in a reflective state, light reflected by the liquid crystal elements at least includes left-handed polarized light; and when the reflective liquid crystal layer of the other liquid crystal element of the adjacent liquid crystal elements is in the reflective state, light reflected by the liquid crystal elements at least comprises right-handed polarized light.

### CROSS-REFERENCE TO RELATED APPLICATION

This application is a national stage application of PCT Application No. PCT/CN2023/122723, which is filed on Sep. 28, 2023 and entitled “Display Device and Driving Method therefor, and Display Apparatus”, the content of which should be regarded as being incorporated herein by reference.

### TECHNICAL FIELD

The present disclosure relates to, but is not limited to, the field of display technologies, and more particularly, to a display device and a driving method therefor, and a display apparatus.

### BACKGROUND

A liquid crystal display apparatus (Liquid Crystal Display, LCD) has characteristics, such as small volume, low power consumption, and no radiation, and has been developed rapidly. A liquid crystal display panel includes a Thin Film Transistor (TFT for short) array substrate and a Color Filter (CF for short) substrate that are in a form of cell. Liquid Crystal (LC for short) molecules are provided between the array substrate and the color filter substrate. By controlling a common electrode and a pixel electrode, an electric field for driving the liquid crystal to deflect is formed, thereby implementing gray scale display. Liquid crystals may be cholesteric phase liquid crystals. In this case, the liquid crystal display panel switches between reflective and focal conic states by driving the cholesteric phase liquid crystals, and then displays it with a background color.

### SUMMARY

The following is a summary of subject matter described in the present disclosure in detail. This summary is not intended to limit the protection scope of claims.

According to a first aspect, the present disclosure provides a display device including: a light absorption layer and a liquid crystal element layer disposed on the light absorption layer, the liquid crystal element layer including: at least two liquid crystal elements stacked, wherein a liquid crystal element of the at least two liquid crystal elements includes: a first substrate, a reflective liquid crystal layer, and a second substrate, wherein the first substrate is located on a side of the reflective liquid crystal layer close to the light absorption layer, and the second substrate is located on a side of the reflective liquid crystal layer away from the light absorption layer;
operation states of the reflective liquid crystal layer include: a reflective state and a focal cone state; and
one liquid crystal element of adjacent liquid crystal elements has the reflective liquid crystal layer in the reflective state, with a light reflected by the one liquid crystal element comprising at least a left-handed polarized light; other liquid crystal element of the adjacent liquid crystal elements has the reflective liquid crystal layer in the reflective state, with a light reflected by the other liquid crystal element comprising at least a right-handed polarized light.

In an exemplary implementation mode, the first substrate includes: a first base and a first electrode layer, the second substrate includes: a second base and a second electrode layer, the first electrode layer is located on a side of the first base close to the reflective liquid crystal layer, the second electrode layer is located on a side of the second base close to the reflective liquid crystal layer, and the first base includes: a data signal line and a scan signal line;
the data signal line and the scan signal line intersect to define a plurality of sub-pixels, the first electrode layer includes first electrodes arranged in an array, the second electrode layer includes second electrodes, the reflective liquid crystal layer includes liquid crystals, a sub-pixel of the plurality of sub-pixels includes a first electrode, a liquid crystal, and a second electrode, and the first electrode and the second electrode are transparent electrodes;
an orthographic projection of the first electrode on the first base is at least partially overlapped with an orthographic projection of the second electrode on the first base.

In an exemplary implementation mode, a wavelength L of a light reflected by the liquid crystal in the reflective liquid crystal layer and a distance P between the first electrode and the second electrode of the sub-pixel where the liquid crystal is located satisfy a formula: L=n*t*P, wherein n is an average refractive index of the liquid crystal, and t is a ratio of a pitch of the liquid crystal to a distance between a first electrode and a second electrode of any sub-pixel in the liquid crystal element.

In an exemplary implementation mode, the liquid crystal element reflects light of one color, the liquid crystals are either left-handed cholesteric phase liquid crystals or right-handed cholesteric phase liquid crystals, the liquid crystals are the left-handed cholesteric phase liquid crystals when the liquid crystal element reflects a left-handed polarized light, and the liquid crystals are the right-handed cholesteric phase liquid crystals when the liquid crystal element reflects right-handed polarized light;

The liquid crystals of all sub-pixels are the same, a surface of the first base close to the reflective liquid crystal layer is flat, and a distance between a first electrode and a second electrode for any two sub-pixels of all sub-pixels is equal.

In an exemplary implementation mode, the liquid crystal element reflects light of two colors, the liquid crystals include first liquid crystals and second liquid crystals, the first liquid crystals and the second liquid crystals are either left-handed cholesteric phase liquid crystals or right-handed cholesteric phase liquid crystals, and the first liquid crystals and the second liquid crystals are configured to reflect light of different wavelengths;
the plurality of sub-pixels in the liquid crystal element are arrayed in a first direction and a second direction, the first direction and the second direction intersect; a liquid crystal of one sub-pixel of two sub-pixels arranged in the first direction is a first liquid crystal, a liquid crystal of the other sub-pixel of the two sub-pixels arranged in the first direction is a second liquid crystal, a liquid crystal of one sub-pixel of two sub-pixels arranged in the second direction is a first liquid crystal, and a liquid crystal of the other sub-pixel of the two sub-pixels arranged in the second direction is a second liquid crystal;
a surface of the first base close to the reflective liquid crystal layer is not flat, and a distance between a first electrode and a second electrode of a sub-pixel where a first liquid crystal is located is not equal to a distance between a first electrode and a second electrode of a sub-pixel where a second liquid crystal is located;
when the liquid crystal element reflects the left-handed polarized light, the first liquid crystals and the second liquid crystals are the left-handed cholesteric phase liquid crystals, when the liquid crystal element reflects the right-handed polarized light, the first liquid crystals and the second liquid crystals are the right-handed cholesteric phase liquid crystals, and when the liquid crystal element reflects the left-handed polarized light and the right-handed polarized light, either the first liquid crystals or the second liquid crystals are the left-handed cholesteric phase liquid crystals, and the others of the first liquid crystals and the second liquid crystals are the right-handed cholesteric phase liquid crystals.

In an exemplary implementation mode, the at least two liquid crystal elements include: a first liquid crystal element and a second liquid crystal element;
the first liquid crystal element has the reflective liquid crystal layer in the reflective state, with the first liquid crystal element reflecting light of a first color; the second liquid crystal element has the reflective liquid crystal layer in the reflective state, with the second liquid crystal element reflecting light of a second color.

In an exemplary implementation mode, the first color and the second color are different, and a combined color of the first color and the second color is white;
in a state in which a wavelength of the first color is larger than a wavelength of the second color, a distance between a first electrode and a second electrode of any sub-pixel in the first liquid crystal element is larger than a distance between a first electrode and a second electrode of any sub-pixel in the second liquid crystal element.

In an exemplary implementation mode, the first color is red and the second color is cyan; the distance between the first electrode and the second electrode of any sub-pixel in the first liquid crystal element ranges from 5.8 microns to 6.2 microns; the distance between the first electrode and the second electrode of any sub-pixel in the second liquid crystal element ranges from 3.8 microns to 4.2 microns; or
the first color is yellow and the second color is blue; the distance between the first electrode and the second electrode of any sub-pixel in the first liquid crystal element ranges from 4.8 microns to 5.2 microns; the distance between the first electrode and the second electrode of any sub-pixel in the second liquid crystal element ranges from 3.8 microns to 4.2 microns.

In an exemplary implementation mode, the first color and the second color are the same;
the distance between the first electrode and the second electrode of any sub-pixel in the first liquid crystal element is the same as the distance between the first electrode and the second electrode of any sub-pixel in the second liquid crystal element.

In an exemplary implementation mode, the at least two liquid crystal elements further include: a third liquid crystal element;
the third liquid crystal element has the reflective liquid crystal layer in the reflective state, with the third liquid crystal element reflecting light of a third color;
the first color, the second color, and the third color are different colors, and a combined color of the first color, the second color, and the third color is white.

In an exemplary implementation mode, any two of a distance between a first electrode and a second electrode of any sub-pixel in the first liquid crystal element, a distance between a first electrode and a second electrode of any sub-pixel in the second liquid crystal element, and a distance between a first electrode and a second electrode of any sub-pixel in the third liquid crystal element are different.

In an exemplary implementation mode, the first color is red, the second color is green, and the third color is blue;
the distance between the first electrode and the second electrode of any sub-pixel in the first liquid crystal element ranges from 5.8 microns to 6.2 microns;
the distance between the first electrode and the second electrode of any sub-pixel in the second liquid crystal element ranges from 4.8 microns to 5.2 microns;
the distance between the first electrode and the second electrode of any sub-pixel in the third liquid crystal element ranges from 3.8 microns to 4.2 microns.

In an exemplary implementation mode, the at least two liquid crystal elements include: a first liquid crystal element and a second liquid crystal element;
the first liquid crystals in the first liquid crystal element and the first liquid crystals in the second liquid crystal element are liquid crystals of a first color, and the second liquid crystals in the first liquid crystal element and the second liquid crystals in the second liquid crystal element are liquid crystals of a second color;
the first liquid crystals and the second liquid crystals in the first liquid crystal element are left-handed cholesteric phase liquid crystals, the first liquid crystals and the second liquid crystals in the second liquid crystal element are right-handed cholesteric phase liquid crystals; or the first liquid crystals and the second liquid crystals in the first liquid crystal element are the right-handed cholesteric phase liquid crystals, the first liquid crystals and the second liquid crystals in the second liquid crystal element are the left-handed cholesteric phase liquid crystals; or the first liquid crystals in the first liquid crystal element are the left-handed cholesteric phase liquid crystals, the second liquid crystals in the first liquid crystal element are the right-handed cholesteric phase liquid crystals, the first liquid crystals in the second liquid crystal element are the right-handed cholesteric phase liquid crystals, the second liquid crystals in the second liquid crystal element are the left-handed cholesteric phase liquid crystals; or the first liquid crystals in the first liquid crystal element are the right-handed cholesteric phase liquid crystals, the second liquid crystals in the first liquid crystal element are the left-handed cholesteric phase liquid crystals, the first liquid crystals in the second liquid crystal element are the left-handed cholesteric phase liquid crystals, the second liquid crystals in the second liquid crystal element are the right-handed cholesteric phase liquid crystals;
the liquid crystals of the first color and the liquid crystals of the second color are liquid crystals of different colors, and a combined color of a color of light reflected by the liquid crystals of the first color and a color of light reflected by the liquid crystals of the second color is white.

In an exemplary implementation mode, a distance between a first electrode and a second electrode of a sub-pixel where a first liquid crystal in the first liquid crystal element is located is the same as a distance between a first electrode and a second electrode of a sub-pixel where a first liquid crystal in the second liquid crystal element is located;
a distance between a first electrode and a second electrode of a sub-pixel where a second liquid crystal in the first liquid crystal element is located is the same as a distance between a first electrode and a second electrode of a sub-pixel where a second liquid crystal in the second liquid crystal element is located.

In an exemplary implementation mode, when the liquid crystals of the first color and the liquid crystals of the second color are either red cholesteric phase liquid crystals or cyan cholesteric phase liquid crystals, a distance between a first electrode and a second electrode of a sub-pixel where a liquid crystal reflecting a red light is located is greater than a distance between a first electrode and a second electrode of a sub-pixel where a liquid crystal reflecting a cyan light is located;
when the liquid crystals of the first color and the liquid crystals of the second color are either yellow cholesteric phase liquid crystals or blue cholesteric phase liquid crystals, a distance between a first electrode and a second electrode of a sub-pixel where a liquid crystal reflecting a yellow light is located is greater than a distance between a first electrode and a second electrode of a sub-pixel where a liquid crystal reflecting a blue light is located.

In an exemplary implementation mode, an orthographic projection of a sub-pixel including a first liquid crystal in the first liquid crystal element on the light absorption layer is at least partially overlapped with an orthographic projection of a sub-pixel including a first liquid crystal in the second liquid crystal element on the light absorption layer, and the orthographic projection of the sub-pixel including the first liquid crystal in the first liquid crystal element on the light absorption layer is not overlapped with an orthographic projection of a sub-pixel including a second liquid crystal in the second liquid crystal element on the light absorption layer;
an orthographic projection of a sub-pixel including a second liquid crystal in the first liquid crystal element on the light absorption layer is at least partially overlapped with the orthographic projection of the sub-pixel including the second liquid crystal in the second liquid crystal element on the light absorption layer, and the orthographic projection of the sub-pixel including the second liquid crystal in the first liquid crystal element on the light absorption layer is not overlapped with the orthographic projection of the sub-pixel including the first liquid crystal in the second liquid crystal element on the light absorption layer.

In an exemplary implementation mode, the at least two liquid crystal elements include: a first liquid crystal element, a second liquid crystal element, and a third liquid crystal element;
the first liquid crystals in the first liquid crystal element and the first liquid crystals in the second liquid crystal element are liquid crystals of a first color, the second liquid crystals in the first liquid crystal element and the first liquid crystals in the third liquid crystal element are liquid crystals of a second color, and the second liquid crystals in the second liquid crystal element and the second liquid crystals in the third liquid crystal element are liquid crystals of a third color;
either the first liquid crystals in the first liquid crystal element or the first liquid crystals in the second liquid crystal element are left-handed cholesteric phase liquid crystals, the others of the first liquid crystals in the first liquid crystal element and the first liquid crystals in the second liquid crystals element are right-handed cholesteric phase liquid crystals, either the second liquid crystals in the first liquid crystal element or the first liquid crystals in the third liquid crystal element are the left-handed cholesteric phase liquid crystals, either the second liquid crystals in the first liquid crystal element or the first liquid crystals in the third liquid crystal element are the right-handed cholesteric phase liquid crystal, either the second liquid crystals in the second liquid crystal element or the second liquid crystals in the third liquid crystal element are the left-handed cholesteric phase liquid crystals, the others of the second liquid crystals in the second liquid crystal element and the second liquid crystals in the third liquid crystals element are the right-handed cholesteric phase liquid crystals, the first liquid crystals and the second liquid crystals in the first liquid crystal element are the left-handed cholesteric phase liquid crystals or the right-handed cholesteric phase liquid crystals, either the first liquid crystals or the second liquid crystals in the second liquid crystal element are the left-handed cholesteric phase liquid crystals, the others of the first liquid crystals and the second liquid crystals in the second liquid crystal element are the right-handed cholesteric phase liquid crystals, and the first liquid crystals and the second liquid crystals in the third liquid crystal element are the left-handed cholesteric phase liquid crystals or the right-handed cholesteric phase liquid crystals;
the liquid crystals of the first color, the liquid crystals of the second color, and the liquid crystals of the third color are liquid crystals of different colors, and a combined color of light reflected by the liquid crystals of the first color, light reflected by the liquid crystals of the second color, and light reflected by the liquid crystals of the third color is white.

In an exemplary implementation mode, a distance between a first electrode and a second electrode of a sub-pixel where a first liquid crystal in the first liquid crystal element is located is the same as a distance between a first electrode and a second electrode of a sub-pixel where a first liquid crystal in the second liquid crystal element is located;
a distance between a first electrode and a second electrode of a sub-pixel where a second liquid crystal in the first liquid crystal element is located is the same as a distance between a first electrode and a second electrode of a sub-pixel where a first liquid crystal in the third liquid crystal element is located;
a distance between a first electrode and a second electrode of a sub-pixel where a second liquid crystal in the second liquid crystal element is located is the same as a distance between a first electrode and a second electrode of a sub-pixel where a second liquid crystal in the third liquid crystal element is located.

In an exemplary implementation mode, the liquid crystals of the first color, the liquid crystals of the second color, and the liquid crystals of the third color are one of red cholesteric phase liquid crystals, green cholesteric phase liquid crystals, and blue cholesteric phase liquid crystals;
a distance between a first electrode and a second electrode of a sub-pixel where a red cholesteric phase liquid crystal is located is greater than a distance between a first electrode and a second electrode of a sub-pixel where a green cholesteric phase liquid crystal is located, and the distance between the first electrode and the second electrode of the sub-pixel where the green cholesteric phase liquid crystal is located is greater than a distance between a first electrode and a second electrode of a sub-pixel where a blue cholesteric phase liquid crystal is located.

In an exemplary implementation mode, the distance between the first electrode and the second electrode of the sub-pixel where the red cholesteric phase liquid crystal is located ranges from 5.8 microns to 6.2 microns;
the distance between the first electrode and the second electrode of the sub-pixel where the green cholesteric phase liquid crystal is located ranges from 4.8 microns to 5.2 microns;
the distance between the first electrode and the second electrode of the sub-pixel where the blue cholesteric phase liquid crystal is located ranges from 3.8 microns to 4.2 microns.

In an exemplary implementation mode, the liquid crystal element further includes: an isolation structure and a sealant disposed between the first substrate and the second substrate, and the reflective liquid crystal layer is filled in an area enclosed by the sealant, the first substrate and the second substrate;
the isolation structure divides the area enclosed by the sealant, the first substrate and the second substrate into a first area and a second area, the first area and the second area are independent of each other, the sealant is provided with a first crystal filling port and a second crystal filling port, the first crystal filling port is configured to fill first liquid crystals into one of the first area and the second area, the second crystal filling port is configured to fill second liquid crystals into the other of the first area and the second area, the liquid crystals in the first area are communicated with each other, and the liquid crystals in the second area are communicated with each other.

In an exemplary implementation mode, the isolation structure includes: a first connection portion, a second connection portion, N third connection portions, N−1 fourth connection portions, and N is a positive integer greater than or equal to 2;
the first connection portion, the second connection portion, and the fourth connection portions extend in a first direction, the third connection portions extend in a second direction, and the first direction and the second direction intersect;
one end of the first connection portion is connected with a middle portion of a first inner wall of the sealant, the other end of the first connection portion is connected with a middle portion of a first third connection portion, one end of the first third connection portion is connected with one end of a first fourth connection portion, the other end of the first fourth connection portion is connected with one end of a second third connection portion, the other end of an i-th third connection portion is connected with one end of an i-th fourth connection portion, the other end of the i-th fourth connection portion is connected with one end of an (i+1)-th third connection portion, one end of the second connection portion is connected with a middle portion of a second inner wall of the sealant, and the other end of the second connection portion is connected with a middle portion of an N-th third connection portion; the first inner wall and the second inner wall are disposed opposite each other, and 2≤i≤N−1;
a length of a third connection portion in the second direction is larger than a length of any one of the first connection portion, the second connection portion, and a fourth connection portion in the first direction.

In an exemplary implementation mode, further including: a protective cover plate;
the protective cover plate is located on a side of the liquid crystal element layer away from the light absorption layer.

In an exemplary implementation mode, a distance between the protective cover plate and the liquid crystal element layer ranges from 1 mm to 1.5 mm;
the protective cover plate has a haze ranging from 10% to 15%.

In an exemplary implementation mode, liquid crystals in the reflective liquid crystal layer that reflects left-handed polarized light in the reflective state are doped with a left-handed chiral agent, and liquid crystals in the reflective liquid crystal layer that reflects right-handed polarized light in the reflective state are doped with a right-handed chiral agent.

In an exemplary implementation mode, the reflective liquid crystal layer includes an acrylic polymer, wherein a content of the acrylic polymer ranges from 3% to 5%.

In an exemplary implementation mode, the second base includes: a black matrix layer, and an orthographic projection of the black matrix layer on the first base is at least partially overlapped with orthographic projections of the data signal line and the scan signal line on the first base;
the black matrix layer includes: a first black matrix structure and a second black matrix structure, an orthographic projection of the first black matrix structure on the light absorption layer is at least partially overlapped with an orthographic projection of the data signal line on the light absorption layer, an orthographic projection of the second black matrix structure on the light absorption layer is at least partially overlapped with an orthographic projection of the scan signal line on the light absorption layer;
a distance between the orthographic projection of the first black matrix structure on the light absorption layer and an orthographic projection of a first electrode of any one of two adjacent sub-pixels located on both sides of the data signal line on the light absorption layer is a first distance, a distance between the orthographic projection of the second black matrix structure on the light absorption layer and an orthographic projection of a first electrode of any one of two adjacent sub-pixels located on both sides of the scan signal line on the light absorption layer is a second distance, and the first distance is larger than the second distance;
a distance between an orthographic projection of a boundary of the data signal line close to one of the two adjacent sub-pixels located on both sides of the data signal line on the light absorption layer and an orthographic projection of a boundary of the first black matrix structure close to the other of the two adjacent sub-pixels located on both sides of the data signal line on the light absorption layer is larger than a bonding deviation of adjacent liquid crystal elements;
a distance between an orthographic projection of a boundary of the scan signal line close to one of the two adjacent sub-pixels located on both sides of the scan signal line on the light absorption layer and an orthographic projection of a boundary of the second black matrix structure close to the other of the two adjacent sub-pixels located on both sides of the scan signal line on the light absorption layer is larger than the bonding deviation of the adjacent liquid crystal elements.

In an exemplary implementation mode, a bonding deviation of adjacent liquid crystal elements is less than or equal to 5 microns.

In an exemplary implementation mode, the liquid crystal element further includes a driver;
the driver is disposed on the first substrate, and the driver is configured to provide signals to the first substrate and the second substrate such that the reflective liquid crystal layer switches between the focal cone state and the reflective state;
an orthographic projection of the second substrate on the first base is not overlapped with an orthographic projection of the driver on the first base.

According to a second aspect, the present disclosure provides a display apparatus, including the above display device.

According to a first aspect, the present disclosure provides a driving method of a display device, configured for driving the above display device, the method including:
providing signals to first substrates and second substrates of at least two liquid crystal elements such that reflective liquid crystal layers of the at least two liquid crystal elements switch between the focal cone state and the reflective state.

In an exemplary implementation mode, the at least two liquid crystal elements include a first liquid crystal element that reflects light of a first color and a second liquid crystal element that reflects light of a second color, and the first color and the second color are different;
providing the signals to the first substrates and the second substrates of the at least two liquid crystal elements such that the reflective liquid crystal layers of the at least two liquid crystal elements switch between the focal cone state and the reflective state includes:
providing signals to a first substrate and a second substrate of the first liquid crystal element such that a reflective liquid crystal layer of the first liquid crystal element is in the focal cone state, providing signals to a first substrate and a second substrate of the second liquid crystal element such that a reflective liquid crystal layer of the second liquid crystal element is in the focal cone state, and the display device displays black;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, and the display device displays the first color;
providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, and the display device displays a second color; and
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, and the display device displays a combined color of the first color and the second color.

In an exemplary implementation mode, the at least two liquid crystal elements include: a first liquid crystal element that reflects light of a first color, a second liquid crystal element that reflects light of a second color, and a third liquid crystal element that reflects light of a third color, and any two of the first color, the second color, and the third color are different;
providing the signals to the first substrates and the second substrates of the at least two liquid crystal elements such that the reflective liquid crystal layers of the at least two liquid crystal elements switch between the focal cone state and the reflective state includes:
providing signals to a first substrate and a second substrate of the first liquid crystal element such that a reflective liquid crystal layer of the first liquid crystal element is in the focal cone state, providing signals to a first substrate and a second substrate of the second liquid crystal element such that a reflective liquid crystal layer of the second liquid crystal element is in the focal cone state, providing signals to a first substrate and a second substrate of the third liquid crystal element such that a reflective liquid crystal layer of the third liquid crystal element is in the focal cone state, and the display device displays black;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the focal cone state, and the display device displays the first color;
providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the focal cone state, and the display device displays the second color;
providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the reflective state, and the display device displays the third color;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the focal cone state, and the display device displays a combined color of the first color and the second color;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the reflective state, and the display device displays a combined color of the first color and the third color;
providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the reflective state, and the display device displays a combined color of the second color and the third color;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the reflective state, and the display device displays a combined color of the first color, the second color and the third color.

In an exemplary implementation mode, the at least two liquid crystal elements include: a first liquid crystal element and a second liquid crystal element, first liquid crystals in the first liquid crystal element and first liquid crystals in the second liquid crystal element are liquid crystals of a first color, second liquid crystals in the first liquid crystal element and second liquid crystals in the second liquid crystal element are liquid crystals of a second color, and the liquid crystals of the first color and the liquid crystals of the second color are liquid crystals of different colors;
providing the signals to the first substrates and the second substrates of the at least two liquid crystal elements such that the reflective liquid crystal layers of the at least two liquid crystal elements switch between the focal cone state and the reflective state includes:
providing signals to a first substrate and a second substrate of the first liquid crystal element such that the first liquid crystals and the second liquid crystals in a reflective liquid crystal layer of the first liquid crystal element are in the focal cone state, providing signals to a first substrate and a second substrate of the second liquid crystal element such that the first liquid crystals and the second liquid crystals in a reflective liquid crystal layer of the second liquid crystal element are in the focal cone state, and the display device displays black;
providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the reflective state and the focal cone state, respectively, and the display device displays the first color;
providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the focal cone state and the reflective state, respectively, and the display device displays the second color;
providing signals to a first substrate and a second substrate of the first liquid crystal element such that the first liquid crystals and the second liquid crystals in the reflective liquid crystal layer of the first liquid crystal element are in the reflective state, providing signals to a first substrate and a second substrate of the second liquid crystal element such that the first liquid crystals and the second liquid crystals in the reflective liquid crystal layer of the second liquid crystal element are in the reflective state, and the display device displays a combined color of the first color and the second color.

In an exemplary implementation mode, the at least two liquid crystal elements include: a first liquid crystal element, a second liquid crystal element, and a third liquid crystal element, first liquid crystals in the first liquid crystal element and first liquid crystals in the second liquid crystal element are liquid crystals of a first color, second liquid crystals in the first liquid crystal element and first liquid crystals in the third liquid crystal element are liquid crystals of a second color, and second liquid crystals in the second liquid crystal element and second liquid crystals in the third liquid crystal element are liquid crystals of a third color;
providing the signals to the first substrates and the second substrates of the at least two liquid crystal elements such that the reflective liquid crystal layers of the at least two liquid crystal elements switch between the focal cone state and the reflective state includes:
providing signals to a first substrate and a second substrate of the first liquid crystal element such that the first liquid crystals and the second liquid crystals in a reflective liquid crystal layer of the first liquid crystal element are in the focal cone state, providing signals to a first substrate and a second substrate of the second liquid crystal element such that the first liquid crystals and the second liquid crystals in a reflective liquid crystal layer of the second liquid crystal element are in the focal cone state, providing signals to a first substrate and a second substrate of the third liquid crystal element such that the first liquid crystals and the second liquid crystals in a reflective liquid crystal layer of the third liquid crystal element are in the focal cone state, and the display device displays black;
providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the reflective state and the focal cone state, respectively, providing signals to the first substrate and the second substrate of the third liquid crystal element such that the first liquid crystals and the second liquid crystals in the reflective liquid crystal layer of the third liquid crystal element are in the focal cone state, and the display device displays the first color;
providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the focal cone state, providing signals to the first substrate and the second substrate of the third liquid crystal element such that the first liquid crystals and the second liquid crystals in the reflective liquid crystal layer of the third liquid crystal element are in the reflective state and the focal cone state, respectively, and the display device displays the second color;
providing signals to the first substrate and the second substrate of the first liquid crystal element such that the first liquid crystals and the second liquid crystals in the reflective liquid crystal layer of the first liquid crystal element are in the focal cone state, providing signals to the first substrate and the second substrate of the second liquid crystal element such that the first liquid crystals and the second liquid crystals in the reflective liquid crystal layer of the second liquid crystal element are in the focal cone state and the reflective state, respectively, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays the third color;
providing signals to the first substrate and the second substrate of the first liquid crystal element such that the first liquid crystals and the second liquid crystals in the reflective liquid crystal layer of the first liquid crystal element are in the reflective state, providing signals to the first substrate and the second substrate of the second liquid crystal element such that the first liquid crystals and the second liquid crystals in the reflective liquid crystal layer of the second liquid crystal element are in the reflective state and the focal cone state, respectively, providing signals to the first substrate and the second substrate of the third liquid crystal element such that the first liquid crystals and the second liquid crystals in the reflective liquid crystal layer of the third liquid crystal element are in the reflective state and the focal cone state, respectively, and the display device displays a combined color of the first color and the second color;
providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the focal cone state and the reflective state, respectively, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays a combined color of the first color and the third color;
providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the reflective state, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays a combined color of the second color and the third color;
providing signals to the first substrate and the second substrate of the first liquid crystal element such that the first liquid crystals and the second liquid crystals in the reflective liquid crystal layer of the first liquid crystal element are in the reflective state, providing signals to the first substrate and the second substrate of the second liquid crystal element such that the first liquid crystals and the second liquid crystals in the reflective liquid crystal layer of the second liquid crystal element are in the reflective state, providing signals to the first substrate and the second substrate of the third liquid crystal element such that the first liquid crystals and the second liquid crystals in the reflective liquid crystal layer of the third liquid crystal element are in the reflective state, and the display device displays a combined color of the first color, the second color and the third color.

Other aspects of the present disclosure may be comprehended after the drawings and the detailed descriptions are read and understood.

### BRIEF DESCRIPTION OF DRAWINGS

Accompanying drawings are used to provide an understanding of technical solutions of the present disclosure, and form a part of the specification. The accompanying drawings and embodiments of the present disclosure are adopted to explain the technical solutions of the present disclosure, and do not form limitations on the technical solutions of the present disclosure.

FIG. 1 is a schematic diagram of a structure of a display device provided by an embodiment of the present disclosure.

FIG. 2 is a cross-sectional diagram of a liquid crystal element.

FIG. 3 is a first partial schematic diagram of a liquid crystal display panel.

FIG. 4 is a second partial schematic diagram of a liquid crystal display panel.

FIG. 5 is a first schematic diagram of a structure of a display device provided by an exemplary implementation mode.

FIG. 6 is a schematic diagram of reflection spectra of a liquid crystal of a first liquid crystal element and a liquid crystal of a second liquid crystal element in the display device provided in FIG. 5.

FIG. 7 is a second schematic diagram of a structure of a display device provided by an exemplary implementation mode.

FIG. 8 is a schematic diagram of reflection spectra of a liquid crystal of a first liquid crystal element and a liquid crystal of a second liquid crystal element in the display device provided in FIG. 7.

FIG. 9 is a third schematic diagram of a structure of a display device provided by an exemplary implementation mode.

FIG. 10 is a schematic diagram of reflection spectra of a liquid crystal of a first liquid crystal element to a liquid crystal of a third liquid crystal element in the display device provided in FIG. 9.

FIG. 11 is a fourth schematic diagram of a structure of a display device provided by an exemplary implementation mode.

FIG. 12 is a fifth schematic diagram of a structure of a display device provided by an exemplary implementation mode.

FIG. 13 is a sixth schematic diagram of a structure of a display device provided by an exemplary implementation mode.

FIG. 14 is a partial schematic diagram of a first liquid crystal element of FIG. 13.

FIG. 15 is a partial schematic diagram of a second liquid crystal element of FIG. 13.

FIG. 16 is a partial schematic diagram of a third liquid crystal element of FIG. 13.

FIG. 17 is a top view of a liquid crystal element.

FIG. 18 is a schematic diagram of a structure of an isolation structure.

FIG. 19 is a schematic diagram of another structure of a display device.

FIG. 20 is another top view of a liquid crystal element.

FIG. 21 is a cross-sectional diagram taken along an A-A direction in FIG. 20.

FIG. 22 is a cross-sectional diagram taken along a B-B direction in FIG. 20.

FIG. 23 is a side view of a display apparatus provided by an embodiment of the present disclosure.

FIG. 24 is an enlarged view of a portion within a dashed box in FIG. 23.

### DETAILED DESCRIPTION

The present disclosure describes multiple embodiments, but the description is exemplary rather than restrictive. For those of ordinary skills in the art, there may be more embodiments and implementations in the scope of the embodiments described in the present disclosure. Although many possible combinations of features are shown in the accompanying drawings and discussed in specific implementations, many other combinations of the disclosed features are also possible. Unless expressly limited, any feature or element of any embodiment may be used in combination with, or may replace, any other feature or element in any other embodiment.

The present disclosure includes and conceives combinations with the features and elements known to those of ordinary skills in the art. The embodiments, features and elements that have been disclosed in the present disclosure may also be combined with any conventional features or elements to form technical solutions defined by the claims. Any features or elements of any embodiment may also be combined with features or elements from other technical solutions to form another technical solution defined by the claims. Therefore, it should be understood that any of the features shown and/or discussed in the present disclosure may be implemented alone or in any suitable combination. Therefore, the embodiments are not to be limited except the limitations by the appended claims and equivalents thereof. Furthermore, various modifications and variations may be made within the protection scope of the appended claims.

Unless otherwise defined, the technical or scientific terms used in the present disclosure shall have the ordinary meanings understood by those of ordinary skills in the art to which the present disclosure pertains. The term “first”, “second” and similar terms used in the present disclosure do not indicate any order, quantity, or importance, but are used only for distinguishing different components. A word such as “include” or “contain” means that an element or object appearing before the word includes an element or object listed after the word or its equivalents and does not exclude another element or object. “Connect”, “couple”, or similar words are not limited to a physical or mechanical connection, but may include an electrical connection, whether direct or indirect. Terms such as “up”, “down”, “left” or “right” are only used to indicate relative positional relationship, and when an absolute position of a described object is changed, the relative positional relationship may also change correspondingly.

A liquid crystal display panel using cholesteric phase liquid crystal has a low light utilization efficiency, which reduces a reflectivity of the liquid crystal display panel, and thus leads to a poor display effect of the liquid crystal display panel.

Cholesteric phase liquid crystal is a special form of nematic liquid crystal. Molecules of the cholesteric phase liquid crystal are arranged in multiple layers, and long axes of molecules in each planar layer are arranged parallel to each other, but the orientations of the long axes of the molecules between different planar layers are gradually deflected, and directors of each planar layer are twisted layer by layer. The molecules of the cholesteric phase liquid crystal are arranged in a periodic helix along a normal direction of the planar layers. A distance in a normal direction corresponding to a 360° change in the orientations of the long axes of the molecules is referred to as a pitch.

Due to a special helical structure of the cholesteric phase liquid crystal, it has Bragg reflection characteristics, that is, when a wavelength of an incident light satisfies λ=nP, the incident light will be reflected, where λ is a wavelength of the reflected light, P is the pitch of the cholesteric phase liquid crystals, n is an average refractive index of the liquid crystal, and n is relatively fixed, so the wavelength λ of the reflected light of the cholesteric phase liquid crystals can be controlled by adjusting P. The cholesteric phase liquid crystal also has obvious circular dichroism. When a beam of light passes through the cholesteric phase liquid crystal, only a circularly polarized light that satisfies the Bragg reflection formula and has the same helix direction as the cholesteric phase liquid crystal is reflected out, and the rest of the light is transmitted. That is to say, if a beam of light is incident, the cholesteric phase liquid crystal will reflect the same light as the circularly polarized light with the same helix direction.

The cholesteric phase liquid crystal has three states: a planar texture state, a focal cone texture state and a dehelical state. When the cholesteric phase liquid crystal is in a planar texture state, the liquid crystal display panel where the cholesteric phase liquid crystal is located is in a reflective state, and when the cholesteric phase liquid crystal is in a focal cone texture state or a dehelical state, the liquid crystal display panel where the cholesteric phase liquid crystal is located is in a focal cone state. Herein, light transmittance of the liquid crystal display panel where the cholesteric phase liquid crystal is located when the cholesteric phase liquid crystal is in the focal cone texture state is smaller than a light transmittance of the liquid crystal display panel where the cholesteric phase liquid crystal is located when the cholesteric phase liquid crystal is in the dehelical state.

FIG. 1 is a schematic diagram of a structure of a display device provided by an embodiment of the present disclosure, and FIG. 2 is a cross-sectional diagram of a liquid crystal element. As shown in FIGS. 1 and 2, a display device provided by an embodiment of the present disclosure may include a light absorption layer 10 and a liquid crystal element layer 20 disposed on the light absorption layer 10, wherein the liquid crystal element layer 20 includes at least two liquid crystal elements stacked on each other, and a liquid crystal element includes a first substrate 201, a reflective liquid crystal layer 203, and a second substrate 202. Herein, the first substrate 201 is located on a side of the reflective liquid crystal layer 203 close to the light absorption layer 10, and the second substrate 202 is located on a side of the reflective liquid crystal layer 203 away from the light absorption layer 10.

In an exemplary implementation mode, operation states of the reflective liquid crystal layer 203 include a reflective state and a focal cone state. FIG. 1 illustrates K liquid crystal elements 20-1 to 20-K as an example.

In an exemplary implementation mode, the reflective liquid crystal layer reflects at least one of a left-handed polarized light and a right-handed polarized light in the reflective state, a light reflected by a reflective liquid crystal layer of one liquid crystal element of adjacent liquid crystal elements in the reflective state includes at least the left-handed polarized light, and a light reflected by a reflective liquid crystal layer of the other liquid crystal element of the adjacent liquid crystal elements in the reflective state includes at least the right-handed polarized light. Exemplarily, when the reflective liquid crystal layer reflects only one kind of polarized light, a reflective layer of one liquid crystal element of adjacent liquid crystal elements reflects the left-handed polarized light, a reflective layer of the other liquid crystal element of the adjacent liquid crystal elements reflects the right-handed polarized light. When a liquid crystal element reflects both left-handed polarized light and right-handed polarized light, the light reflected by one of the adjacent liquid crystal elements includes left-handed polarized light, and the light reflected by the other adjacent liquid crystal element includes right-handed polarized light. In other words, the display device in the present disclosure can reflect both left-handed polarized light and right-handed polarized light simultaneously.

In an exemplary implementation mode, a liquid crystal element in the reflective state can reflect an incident light with a wavelength which satisfies λ=nP, and the liquid crystal element in the focal cone state can transmit light.

In an exemplary implementation mode, the light absorption layer 10 may be a black substrate.

A display device provided by an embodiment of the present disclosure includes: a light absorption layer and a liquid crystal element layer disposed on the light absorption layer, the liquid crystal element layer including: at least two liquid crystal elements stacked, wherein a liquid crystal element includes: a first substrate, a reflective liquid crystal layer, and a second substrate, and wherein the first substrate is located on a side of the reflective liquid crystal layer close to the light absorption layer, and the second substrate is located on a side of the reflective liquid crystal layer away from the light absorption layer; operation states of the reflective liquid crystal layer include: a reflective state and a focal cone state; a liquid crystal element with a reflective liquid crystal layer in the reflective state reflects at least one of a left-handed polarized light and a right-handed polarized light, and when a reflective liquid crystal layer of one liquid crystal element of adjacent liquid crystal elements is in the reflective state, a light reflected by the one liquid crystal element comprises at least the left-handed polarized light, and when a reflective liquid crystal layer of the other liquid crystal element of the adjacent liquid crystal elements is in the reflective state, a light reflected by the other liquid crystal element comprises at least the right-handed polarized light. By simultaneously reflecting the left-handed polarized light and the right-handed polarized light, the present disclosure improves a light utilization efficiency of the display device, thereby improving reflectivity and a display effect of the display device.

In an exemplary implementation mode, as shown in FIG. 2, the liquid crystal element further includes a driver 204 disposed on the first substrate 201. The driver 204 is configured to provide signals to the first substrate 201 and the second substrate 202 such that the reflective liquid crystal layer 203 switches between the focal cone state and the reflective state.

In an exemplary implementation mode, as shown in FIG. 2, the first substrate 201 may include: a first base 2011 and a first electrode layer 2012, the second substrate 202 may include a second base 2021 and a second electrode layer 2022, where the first electrode layer 2012 is located on a side of the first base 2011 close to the reflective liquid crystal layer 203, the second electrode layer 2022 is located on a side of the second base 2021 close to the reflective liquid crystal layer 203, the first base 2011 includes: data signal lines and scan signal lines (not shown), and the second base 2021 includes: a black matrix layer (not shown).

In an exemplary implementation mode, as shown in FIG. 2, the driver 204 is disposed on the first base 2011 and is electrically connected with the first electrode layer 2012 and the second electrode layer 2022.

In an exemplary implementation mode, the first electrode layer may include first electrodes arranged in an array, and the second electrode layer may include second electrodes. In an exemplary implementation mode, the data signal lines and the scan signal lines intersect to define a plurality of sub-pixels, the reflective liquid crystal layer includes a liquid crystal, and a sub-pixel includes a first electrode, a liquid crystal, and a second electrode.

In an exemplary implementation mode, the liquid crystal may be a cholesteric phase liquid crystal.

In an exemplary implementation mode, an orthographic projection of the driver 204 on the first base 2011 is not overlapped with an orthographic projection of the light absorption layer 10 on the first base 2011.

In an exemplary implementation mode, an orthographic projection of the first electrode on the first base is at least partially overlapped with an orthographic projection of the second electrode on the first base. The at least partial overlap of the orthographic projection of the first electrode on the first base and the orthographic projection of the second electrode on the first base may form an electric field between the first electrode and the second electrode, thereby driving the liquid crystal element.

In an exemplary implementation mode, the orthographic projections of the first electrode and the second electrode on the first base are not overlapped with the orthographic projection of the driver on the first base.

In an exemplary implementation mode, as shown in FIG. 2, an orthographic projection of the second substrate 202 on the first base 2011 is not overlapped with the orthographic projection of the driver 204 on the first base 2011. In the present disclosure, since an alignment mark is disposed at the position where the driver is located, there is no overlapping area between the orthographic projection of the second substrate 202 on the first base 2011 and the orthographic projection of the driver 204 on the first base 2011, such that the alignment mark can be avoided from being covered, and the bonding deviation of adjacent liquid crystal elements can be improved.

In an exemplary implementation mode, an orthographic projection of the black matrix layer on the first base is at least partially overlapped with orthographic projections of the data signal lines and the scan signal lines on the first base.

In an exemplary implementation mode, as shown in FIG. 2, the liquid crystal element further includes a sealant 205 located between the first substrate 201 and the second substrate 202, and the reflective liquid crystal layer 203 is filled in the sealant 205.

In an exemplary implementation mode, the bonding deviation of adjacent liquid crystal elements is less than or equal to 5 microns, which can avoid light leakage, moire pattern and rainbow pattern phenomena in the display device, and can improve the display effect of the display device.

In an exemplary implementation mode, the first substrate 201 and the second substrate 202 are transparent substrates. The transparent substrate may be made of a rigid glass substrate or a flexible plastic substrate, and exemplarily the flexible plastic substrate may be made of one or more materials including silicon, silicon oxide, silicon carbide, polyethylene terephthalate, polyethylene naphthalate, and the like.

In an exemplary implementation mode, the first electrode and the second electrode are transparent electrodes. Exemplarily, materials of the transparent electrodes may include: indium tin oxide, indium zinc oxide, or nano-silver thin film.

In an exemplary implementation mode, by disposing the transparent substrates and disposing transparent electrodes on the transparent substrates, it is advantageous to avoid loss of some wavelength bands of incident light when the liquid crystal element is in the focal cone state.

In an exemplary implementation mode, since the liquid crystal layer in the liquid crystal element of the present disclosure is a reflective liquid crystal layer, display can be realized without disposing a color filter layer on the second substrate. Therefore, a pixel aperture ratio of sub-pixels in the present disclosure is much larger than that of sub-pixels in a display device including the color filter layer, and the pixel aperture ratio of the sub-pixels in the present disclosure may be greater than 85%.

In an exemplary implementation mode, the driver includes: a timing controller, a data driver, a scan driver, and a flexible circuit board. The timing controller is respectively connected with the data driver and the scan driver, the data driver is respectively connected with a plurality of data signal lines, and the scan driver is respectively connected with a plurality of scan signal lines. At least one sub-pixel may include a first electrode and a second electrode and a liquid crystal disposed between the first electrode and the second electrode, and the first electrode or the second electrode is respectively connected with a scan signal line and a data signal line.

In an exemplary implementation mode, the timing controller may provide the data driver with a grayscale value and a control signal which are suitable for a specification of the data driver, provide the scan driver with a clock signal and a scan start signal and the like which are suitable for a specification of the scan driver, and provide the light emitting driver with a clock signal and an emission stop signal and the like which are suitable for a specification of the light emitting driver. The data driver may generate a data voltage to be provided to the data signal line by using the gray-scale value and control signal received from the timing controller. For example, the data driver may sample the gray-scale value by using the clock signal, and apply the data voltage corresponding to the gray-scale value to the data signal line by taking a pixel row as a unit. The scan driver may generate scan signals to be provided to the scan signal lines by receiving the clock signal, the scan starting signal, or the like, from the timing controller. For example, the scan driver may sequentially provide scan signals with on-level pulses to scan signal lines. For example, the scan driver may be constructed in a form of a shift register and may generate a scan signal by sequentially transmitting a scan starting signal provided in a form of an on-level pulse to a next stage circuit under control of the clock signal.

In an exemplary implementation mode, the driver may provide DC signals to the second electrodes.

In an exemplary implementation mode, when the driver makes the reflective liquid crystal layer of the liquid crystal element to be in the reflective state, the driver can make the liquid crystal element to be in a transition state by applying a first AC signal to the first electrodes, and then, the driver can make the reflective liquid crystal layer of the liquid crystal element to be in the reflective state by instantaneously turning off power to 0 volts.

In an exemplary implementation mode, when the driver makes the reflective liquid crystal layer of the liquid crystal element to be in the reflective state, the driver can make the liquid crystal element to be in the focal cone state by applying a second AC signal to the first electrodes and after instantaneous power-off.

In an exemplary implementation mode, a voltage value of the first AC signal is greater than a voltage value of the second AC signal.

In an exemplary implementation mode, the driver may apply the AC signals for a time of 1 second at a frequency of 20 Hertz.

In an exemplary implementation mode, a wavelength L of a light reflected by a liquid crystal in the reflective liquid crystal layer and a distance P between a first electrode and a second electrode of a sub-pixel where the liquid crystal is located satisfy a formula: L=n*t*P, wherein n is an average refractive index of the liquid crystal, and t is a ratio of a pitch of the liquid crystal to a distance between a first electrode and a second electrode of any sub-pixel in a liquid crystal element, that is, a ratio of the wavelength L of the light reflected by the liquid crystal in the reflective liquid crystal layer to the distance between the first electrode and the second electrode of any sub-pixel in the liquid crystal element has a positive proportional relationship.

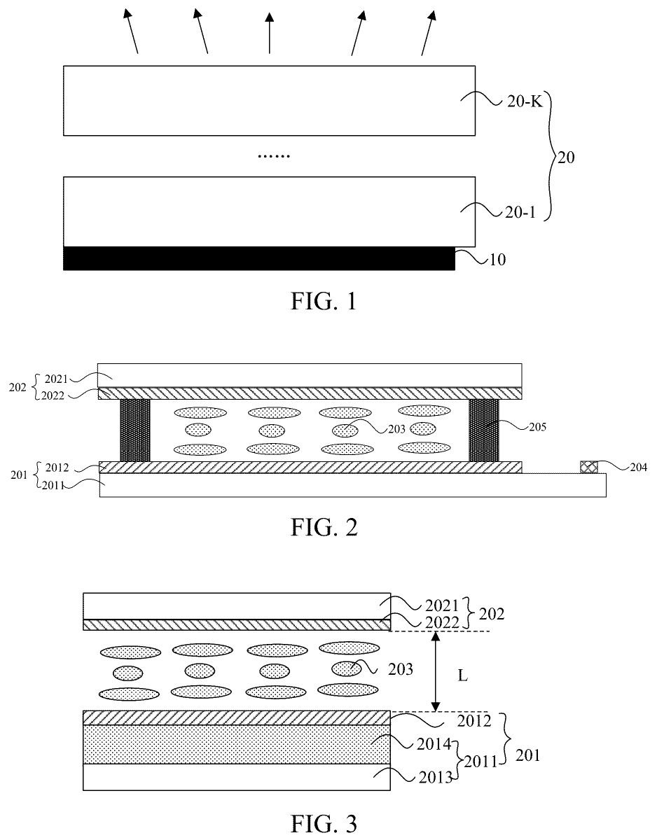

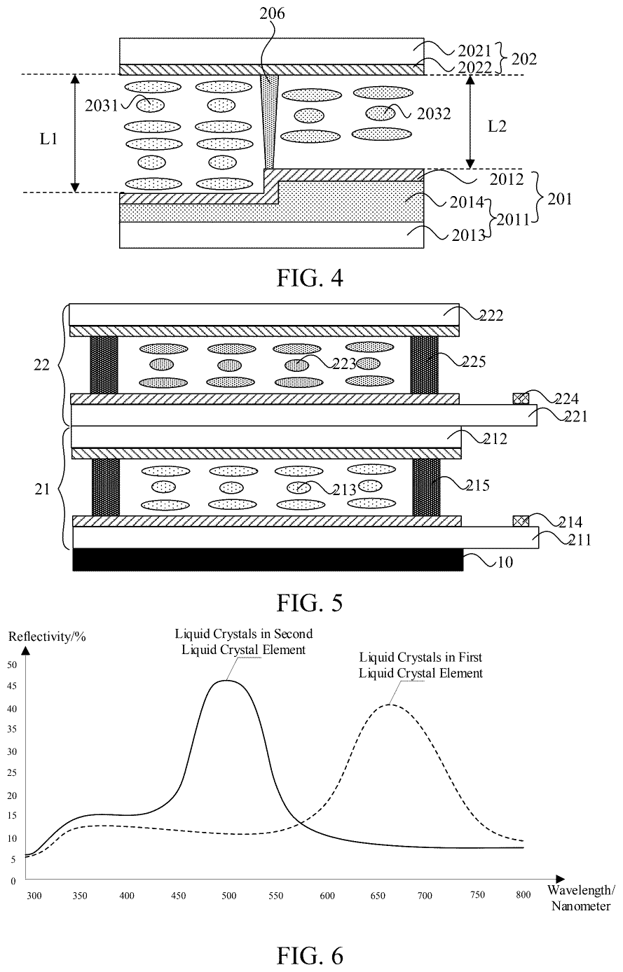

In an exemplary implementation mode, FIG. 3 is a first partial schematic diagram of a liquid crystal display panel, and FIG. 4 is a second partial schematic diagram of a liquid crystal display panel. As shown in FIGS. 3 and 4, the first base 2011 includes a first device layer 2013 and a passivation layer 2014, and the first device layer 2013 further includes a first base substrate and thin film transistors. FIG. 3 illustrates an example in which a liquid crystal element reflects light of one color, and FIG. 4 illustrates an example in which a liquid crystal element reflects light of two colors.

In an exemplary implementation mode, as shown in FIG. 3, the liquid crystal element reflects light of one color, the liquid crystals are either left-handed cholesteric phase liquid crystals or right-handed cholesteric phase liquid crystals, the liquid crystals are the left-handed cholesteric phase liquid crystals when the liquid crystal element reflects a left-handed polarized light, and the liquid crystals are the right-handed cholesteric phase liquid crystals when the liquid crystal element reflects right-handed polarized light.

In an exemplary implementation mode, as shown in FIG. 3, liquid crystals of all sub-pixels are the same, a surface of the first base 2011 close to the reflective liquid crystal layer 203 is flat, and a distance L between a first electrode and a second electrode for any two sub-pixels of all sub-pixels is equal. Herein, a surface of a film layer A close to a film layer B is flat, which means that a difference between a maximum distance between the surface of the film layer A close to the film layer B and the base and a minimum distance between the surface of the film layer A close to the film layer B and the base is less than a first threshold difference, and the first threshold difference may be 0.01 times to 0.02 times the minimum distance between the surface of the film layer A close to the film layer B and the base. The distance L between the first electrode and the second electrode for any two sub-pixels of all sub-pixels is equal, which means that a difference between a maximum distance between the first electrode and the second electrode and a minimum distance between the first electrode and the second electrode in all sub-pixels is less than a second threshold difference. Exemplarily, the second threshold difference may be 0.01 to 0.02 times a minimum distance between a first electrode and a second electrode of a sub-pixel.

In an exemplary implementation mode, as shown in FIG. 4, the liquid crystal element reflects light of two colors, and the liquid crystals include first liquid crystals 2031 and second liquid crystals 2032, the first liquid crystals 2031 and the second liquid crystals 2032 are either left-handed cholesteric phase liquid crystals or right-handed cholesteric phase liquid crystals, and the first liquid crystals 2031 and the second liquid crystals 2032 are configured to reflect light of different wavelengths.

In an exemplary implementation mode, as shown in FIG. 4, the sub-pixels in the liquid crystal element are arrayed in a first direction and a second direction, the first direction and the second direction intersect; a liquid crystal of one sub-pixel of two sub-pixels arranged in the first direction is a first liquid crystal, a liquid crystal of the other sub-pixel of the two sub-pixels arranged in the first direction is a second liquid crystal, a liquid crystal of one sub-pixel of two sub-pixels arranged in the second direction is a first liquid crystal, and a liquid crystal of the other sub-pixel of the two sub-pixels arranged in the second direction is a second liquid crystal. A surface of the first base 2011 close to the reflective liquid crystal layer 203 is not flat, and a distance L1 between a first electrode and a second electrode of a sub-pixel where the first liquid crystal 2031 is located is not equal to a distance L2 between a first electrode and a second electrode of a sub-pixel where the second liquid crystal 2032 is located.

In an exemplary implementation mode, in the display device provided in FIG. 4, when the liquid crystal element reflects the left-handed polarized light, the first liquid crystals and the second liquid crystals are the left-handed cholesteric phase liquid crystals, when the liquid crystal element reflects the right-handed polarized light, the first liquid crystals and the second liquid crystals are the right-handed cholesteric phase liquid crystals, and when the liquid crystal element reflects the left-handed polarized light and the right-handed polarized light, either the first liquid crystals or the second liquid crystals are the left-handed cholesteric phase liquid crystals, and the others of the first liquid crystals and the second liquid crystals are the right-handed cholesteric phase liquid crystals.

In an exemplary implementation mode, as shown in FIG. 4, the display device further includes an isolation structure 206 for separating the first liquid crystals from the second liquid crystals.

In an exemplary implementation mode, FIG. 5 is a first schematic diagram of a structure of a display device provided by an exemplary implementation mode. As shown in FIG. 5, the at least two liquid crystal elements may include a first liquid crystal element 21 and a second liquid crystal element 22. The first liquid crystal element 21 includes a first substrate 211, a second substrate 212, a reflective liquid crystal layer 213, a driver 214, and a sealant 215. The second liquid crystal element 22 includes a first substrate 221, a second substrate 222, a reflective liquid crystal layer 223, a driver 224, and a sealant 225. Herein, when the reflective liquid crystal layer 213 of the first liquid crystal element 21 is in the reflective state, the first liquid crystal element 21 reflects light of a first color, and when the reflective liquid crystal layer 223 of the second liquid crystal element 22 is in the reflective state, the second liquid crystal element 22 reflects light of a second color.

In an exemplary implementation mode, the first color and the second color are different, and a combined color of the first color and the second color is white. Herein, in a state in which a wavelength of the first color is larger than a wavelength of the second color, a distance between a first electrode and a second electrode of any sub-pixel in the first liquid crystal element is larger than a distance between a first electrode and a second electrode of any sub-pixel in the second liquid crystal element. FIG. 5 illustrates an example in which the first color is red and the second color is cyan. The display device provided in FIG. 5 can realize four-color display of black, white, red and cyan by combining two liquid crystal elements that reflect light of different colors in the reflective state with the light absorption layer.

In an exemplary implementation mode, the first liquid crystal element 21 may be located on a side of the second liquid crystal element 22 close to the light absorption layer 10, or may be on a side of the second liquid crystal element 22 away from the light absorption layer 10. FIG. 5 illustrates an example in which the first liquid crystal element 21 may be located on the side of the second liquid crystal element 22 close to the light absorption layer 10.

In an exemplary implementation mode, in the display device provided in FIG. 5, the light of the first color is either the left-handed polarized light or the right-handed polarized light, and the second color light ray is the other of the left-handed polarized light or the right-handed polarized light.

FIG. 6 is a schematic diagram of reflection spectra of liquid crystals of the first liquid crystal element and liquid crystals of the second liquid crystal element in the display device provided in FIG. 5. As shown in FIG. 6, since a center reflection wavelength of the liquid crystals of the first liquid crystal element 21 is larger than a reflection wavelength of the liquid crystals of the second liquid crystal element 22, and according to a formula of a reflection wavelength of a liquid crystal element: λ=Δn*P, it can be seen that λ is proportional to P, that is, a pitch of the liquid crystals of the first liquid crystal element 21 is larger than a pitch of the liquid crystals of the second liquid crystal element 22. Since a pitch of liquid crystals is proportional to a distance between a first electrode and a second electrode of any sub-pixel in a liquid crystal element, in order to match a reflection wavelength and achieve better optical effects, the distance between the first electrode and the second electrode of any sub-pixel in the first liquid crystal element is larger than the distance between the first electrode and the second electrode of any sub-pixel in the second liquid crystal element.

In an exemplary implementation mode, the distance between the first electrode and the second electrode of any sub-pixel in the first liquid crystal element ranges from 5.8 microns to 6.2 microns. Exemplarily, the distance between the first electrode and the second electrode of any sub-pixel in the first liquid crystal element may be 6 microns.

In an exemplary implementation mode, the distance between the first electrode and the second electrode of any sub-pixel in the second liquid crystal element ranges from 3.8 microns to 4.2 microns. Exemplarily, the distance between the first electrode and the second electrode of any of the sub-pixels in the second liquid crystal element may be 4 microns.

In an exemplary implementation mode, when the first color is red, the liquid crystals in the first liquid crystal element 21 are red cholesteric phase liquid crystals, and when the second color is cyan, the liquid crystals in the second liquid crystal element 22 are cyan cholesteric phase liquid crystals.

In an exemplary implementation mode, a bonding deviation between the first liquid crystal element 21 and the second liquid crystal element 22 is less than or equal to 5 microns. Exemplarily, the first liquid crystal element 21 and the second liquid crystal element 22 may be bonded using a high-precision bonding device. If the bonding deviation between the first liquid crystal element 21 and the second liquid crystal element 22 is less than or equal to 5 microns, light leakage, moire pattern, and rainbow pattern phenomena of the display device can be avoided, and the display effect of the display device can be improved.

In the following, it will be described in detail how the display device provided in FIG. 5 realizes four-color display of black, white, red and cyan. Taking the first color as red and the second color as cyan as an example, when the display device displays black, the reflective liquid crystal layer 213 in the first liquid crystal element 21 can be switched to the focal cone state by the driver 214 of the first liquid crystal element 21, and the reflective liquid crystal layer 223 in the second liquid crystal element 22 can be switched to the focal cone state by the driver 224 of the second liquid crystal element 22, the first liquid crystal element 21 and the second liquid crystal element 22 does not reflect corresponding colors, and external light transmits through the second liquid crystal element 22 and the first liquid crystal element 21 to reach the light absorption layer and is absorbed by the light absorption layer. At this time, the device displays black. When the display device displays white, the reflective liquid crystal layer 213 in the first liquid crystal element 21 can be switched to the reflective state by the driver 214 of the first liquid crystal element 21, and the reflective liquid crystal layer 223 in the second liquid crystal element 22 can be switched to the reflective state by the driver 224 of the second liquid crystal element 22, the first liquid crystal element 21 reflects red light, the second liquid crystal element 22 reflects cyan light, and a combination of cyan light and red light displays as white. When the display device displays red, the reflective liquid crystal layer 213 in the first liquid crystal element 21 can be switched to the reflective state by the driver 214 of the first liquid crystal element 21, and the reflective liquid crystal layer 223 in the second liquid crystal element 22 can be switched to the focal cone state by the driver 224 of the second liquid crystal element 22, external light passes through the second liquid crystal element 22 and reaches the first liquid crystal element 21, the first liquid crystal element 21 reflects red light, such that the display device displays red. When the display device displays cyan, the reflective liquid crystal layer 213 in the first liquid crystal element 21 can be switched to the focal cone state by the driver 214 of the first liquid crystal element 21, and the reflective liquid crystal layer 223 in the second liquid crystal element 22 can be switched to the reflective state by the driver 224 of the second liquid crystal element 22. At this time, the second liquid crystal element 22 reflects cyan light, such that the display device displays cyan. The display device provided in FIG. 5 of the present disclosure can realize four-color display of black, white, red and cyan in the above manner, realize multi-color display of the display device, and improve the display effect of the display device.

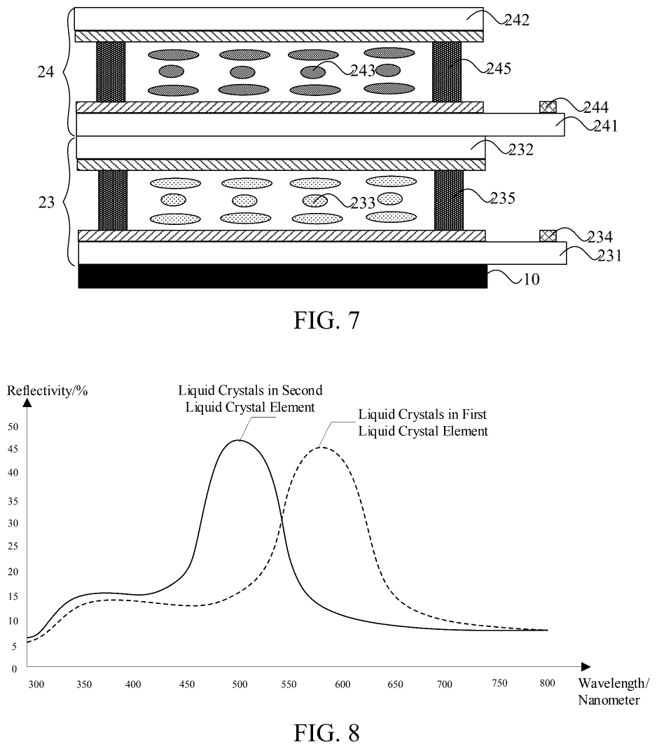

In an exemplary implementation mode, FIG. 7 is a second schematic diagram of a structure of a display device provided by an exemplary implementation mode. As shown in FIG. 7, the at least two liquid crystal elements may include a first liquid crystal element 23 and a second liquid crystal element 24. The first liquid crystal element 23 includes a first substrate 231, a second substrate 232, a reflective liquid crystal layer 233, a driver 234, and a sealant 235. The second liquid crystal element 24 includes a first substrate 241, a second substrate 242, a reflective liquid crystal layer 243, a driver 244, and a sealant 245. Herein, when the reflective liquid crystal layer 233 of the first liquid crystal element 23 is in the reflective state, the first liquid crystal element 23 reflects light of a first color, and when the reflective liquid crystal layer 243 of the second liquid crystal element 24 is in the reflective state, the second liquid crystal element 24 reflects light of the second color.

In an exemplary implementation mode, the first color and the second color are different, and a combined color of the first color and the second color is white. Herein, in a state in which a wavelength of the first color is larger than a wavelength of the second color, a distance between a first electrode and a second electrode of any sub-pixel in the first liquid crystal element is larger than a distance between a first electrode and a second electrode of any sub-pixel in the second liquid crystal element. FIG. 7 illustrates an example in which the first color and the second color are yellow and blue, and the display device provided in FIG. 7 can realize four-color display of black, white, blue and yellow by combining two liquid crystal elements that reflect light of different colors in the reflective state with the light absorption layer.

In an exemplary implementation mode, the first liquid crystal element 23 may be located on a side of the second liquid crystal element 24 close to the light absorption layer 10, or may be on a side of the second liquid crystal element 24 away from the light absorption layer 10. FIG. 7 illustrates an example in which the first liquid crystal element 23 may be located on the side of the second liquid crystal element 24 close to the light absorption layer 10.

In an exemplary implementation mode, in the display device provided in FIG. 7, the light of the first color is one of the left-handed polarized light or the right-handed polarized light, and the light of the second color is the other of the left-handed polarized light or the right-handed polarized light.

FIG. 8 is a schematic diagram of reflection spectra of liquid crystals of the first liquid crystal element and liquid crystals of the second liquid crystal element in the display device provided in FIG. 7. As shown in FIG. 8, since a center reflection wavelength of the liquid crystals of the first liquid crystal element 23 is greater than a reflection wavelength of the liquid crystals of the second liquid crystal element 24, and according to a formula of a reflection wavelength of a liquid crystal element: λ=Δn*P, it can be seen that λ is proportional to P, that is, a pitch of the liquid crystals of the first liquid crystal element 23 is greater than a pitch of the liquid crystals of the second liquid crystal element 24. Since a pitch of liquid crystals is proportional to a distance between a first electrode and a second electrode of any sub-pixel in a liquid crystal element, in order to match a reflection wavelength and achieve better optical effects, the distance between the first electrode and the second electrode of any sub-pixel in the first liquid crystal element is larger than the distance between the first electrode and the second electrode of any sub-pixel in the second liquid crystal element.

In an exemplary implementation mode, the distance between the first electrode and the second electrode of any sub-pixel in the first liquid crystal element ranges from 4.8 microns to 5.2 microns. Exemplarily, the distance between the first electrode and the second electrode of any sub-pixel in the first liquid crystal element may be 5 microns.

In an exemplary implementation mode, the distance between the first electrode and the second electrode of any sub-pixel in the second liquid crystal element ranges from 3.8 microns to 4.2 microns. Exemplarily, the distance between the first electrode and the second electrode of any sub-pixel in the second liquid crystal element may be 4 microns.

In an exemplary implementation mode, a bonding deviation between the first liquid crystal element 23 and the second liquid crystal element 24 is less than or equal to 5 microns. Exemplarily, the first liquid crystal element 23 and the second liquid crystal element 24 may be bonded using a high-precision bonding apparatus. If the bonding deviation of the first liquid crystal element 23 and the second liquid crystal element 24 is less than or equal to 5 microns, light leakage, moire pattern and rainbow pattern phenomena of the display device can be avoided, and the display effect of the display device can be improved.

In the following, it will be described in detail how the display device provided in FIG. 7 realizes four-color display of black, white, blue and yellow. Taking the first color as blue and the second color as yellow as an example, when the display device displays black, the reflective liquid crystal layer 233 in the first liquid crystal element 23 can be switched to the focal cone state by the driver 234 of the first liquid crystal element 23, and the reflective liquid crystal layer 243 in the second liquid crystal element 24 can be switched to the focal cone state by the driver 244 of the second liquid crystal element 24, the first liquid crystal element 23 and the second liquid crystal element 24 do not reflect corresponding colors, and external light transmits through the first liquid crystal element 23 and the second liquid crystal element 24 to reach the light absorption layer 10 and is absorbed by the light absorption layer 10. At this time, the device displays black. When the display device displays white, the reflective liquid crystal layer 233 in the first liquid crystal element 23 can be switched to the reflective state by the driver 234 of the first liquid crystal element 23, and the reflective liquid crystal layer 243 in the second liquid crystal element 24 can be switched to the reflective state by the driver 244 of the second liquid crystal element 24, the first liquid crystal element 23 reflects blue light, the second liquid crystal element 24 reflects yellow light, and a combination of the yellow light and the blue light displays as white. When the display device displays blue, the reflective liquid crystal layer 233 in the first liquid crystal element 23 can be switched to the reflective state by the driver 234 of the first liquid crystal element 23, and the reflective liquid crystal layer 243 in the second liquid crystal element 24 can be switched to the focal cone state by the driver 244 of the second liquid crystal element 24, external light passes through the second liquid crystal element 24 and reaches the first liquid crystal element 23, the first liquid crystal element 23 reflects blue light, such that the display device displays blue. When the display device displays yellow, the reflective liquid crystal layer 233 in the first liquid crystal element 23 can be switched to the focal cone state by the driver 234 of the first liquid crystal element 23, and the reflective liquid crystal layer 243 in the second liquid crystal element 24 can be switched to the reflective state by the driver 244 of the second liquid crystal element 24. At this time, the second liquid crystal element 24 reflects yellow light, such that the display device displays yellow. The display device provided in FIG. 7 of the present disclosure can realize four-color display of black, white, blue and yellow in the above manner, realizing multi-color display of the display device and improving the display effect of the display device.

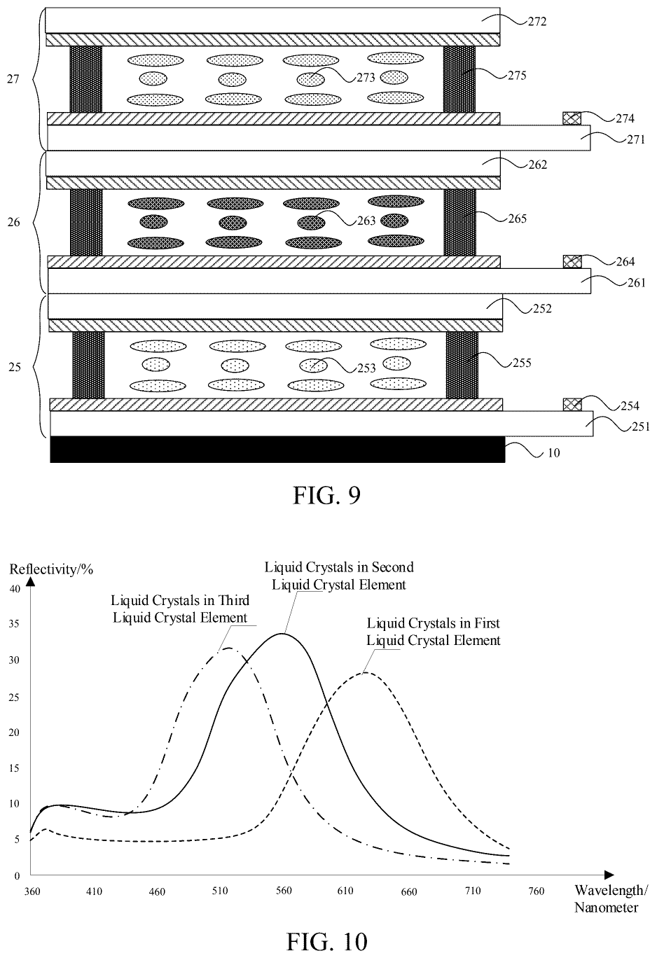

In an exemplary implementation mode, FIG. 9 is a third schematic diagram of a structure of a display device provided by an exemplary implementation mode. As shown in FIG. 9, the at least two liquid crystal elements may include a first liquid crystal element 25, a second liquid crystal element 26, and a third liquid crystal element 27. Herein, the first liquid crystal element 25 includes a first substrate 251, a second substrate 252, a reflective liquid crystal layer 253, a driver 254, and a sealant 255. The second liquid crystal element 26 includes a first substrate 261, a second substrate 262, a reflective liquid crystal layer 263, driver 264, and a sealant 265. The third liquid crystal element 27 includes a first substrate 271, a second substrate 272, a reflective liquid crystal layer 273, driver 274, and a sealant 275. When the reflective liquid crystal layer 253 of the first liquid crystal element 25 is in the reflective state, the first liquid crystal element 25 reflects light of a first color, when the reflective liquid crystal layer 263 of the second liquid crystal element 26 is in the reflective state, the second liquid crystal element 26 reflects light of a second color, and when the reflective liquid crystal layer 273 of the third liquid crystal element 27 is in the reflective state, the third liquid crystal element 27 reflects light of a third color; any two of the first color, the second color, and the third color are different, and a combined color of the first color, the second color, and the third color is white. The display device provided in FIG. 9 can realize color display by combining three liquid crystal elements that reflect light of different colors in the reflective state with the light absorption layer 10.

In an exemplary implementation mode, as shown in FIG. 9, any two of a distance between a first electrode and a second electrode of any sub-pixel in the first liquid crystal element 25, a distance between a first electrode and a second electrode of any sub-pixel in the second liquid crystal element 26, and a distance between a first electrode and a second electrode of any sub-pixel in the third liquid crystal element 27 are different.

In an exemplary implementation mode, the first color is red, the second color is green, and the third color is blue.

FIG. 10 is a schematic diagram of reflection spectra of liquid crystals of the first liquid crystal element to liquid crystals of the third liquid crystal element in the display device provided in FIG. 9. As shown in FIG. 10, a center reflection wavelength of the liquid crystals of the first liquid crystal element 25 is larger than a center reflection wavelength of liquid crystals of the second liquid crystal element 26, and the center reflection wavelength of the liquid crystals of the second liquid crystal element 26 is larger than a center reflection wavelength of the liquid crystals of the third liquid crystal element 27, and according to a formula of a reflection wavelength of a liquid crystal element: λ=Δn*P, it can be seen that λ is proportional to P, that is, a pitch of the liquid crystals of the first liquid crystal element 25 is larger than a pitch of the liquid crystals of the second liquid crystal element 26, and the pitch of the liquid crystals of the second liquid crystal element 26 is larger than a pitch of the liquid crystals of the third liquid crystal element 27. Since a pitch of liquid crystals is proportional to a distance between a first electrode and a second electrode of any sub-pixel in a liquid crystal element, in order to match a reflection wavelength and achieve better optical effects, the distance between the first electrode and the second electrode of any sub-pixel in the first liquid crystal element is larger than the distance between the first electrode and the second electrode of any sub-pixel in the second liquid crystal element, and the distance between the first electrode and the second electrode of any sub-pixel in the second liquid crystal element is larger than the distance between the first electrode and the second electrode of any sub-pixel in the third liquid crystal element.

In an exemplary implementation mode, the distance between the first electrode and the second electrode of any sub-pixel in the first liquid crystal element ranges from 5.8 microns to 6.2 microns. Exemplarily, the distance between the first electrode and the second electrode of any sub-pixel in the first liquid crystal element may be 6 microns.

In an exemplary implementation mode, the distance between the first electrode and the second electrode of any sub-pixel in the second liquid crystal element ranges from 4.8 microns to 5.2 microns. Exemplarily, the distance between the first electrode and the second electrode of any sub-pixel in the second liquid crystal element may be 5 microns.

In an exemplary implementation mode, the distance between the first electrode and the second electrode of any sub-pixel in the third liquid crystal element ranges from 3.8 microns to 4.2 microns. Exemplarily, the distance between the first electrode and the second electrode of any sub-pixel in the third liquid crystal element may be 4 microns.

In an exemplary implementation mode, as shown in FIG. 9, the first liquid crystal element 25 may be located on a side of the second liquid crystal element 26 close to the light absorption layer 10, and the third liquid crystal element 27 may be located on a side of the second liquid crystal element 26 away from the light absorption layer 10. At this time, the light of the first color and the light of the third color are one of the left-handed polarized light or the right-handed polarized light, and the light of the second color is the other of the left-handed polarized light or the right-handed polarized light.

In an exemplary implementation mode, a bonding deviation of adjacent liquid crystal elements (such as the first liquid crystal element 25 and the second liquid crystal element 26, and the second liquid crystal element 26 and the third liquid crystal element 27) is less than or equal to 5 microns. Exemplarily, the first liquid crystal element 25 and the second liquid crystal element 26, and the second liquid crystal element 26 and the third liquid crystal element 27 may be bonded using a high-precision bonding apparatus. If a bonding deviation of the first liquid crystal element 25 and the second liquid crystal element 26 and a bonding deviation of the second liquid crystal element 26 and the third liquid crystal element 27 are less than or equal to 5 microns, light leakage, moire pattern and rainbow pattern phenomena of the display device can be avoided, and the display effect of the display device can be improved.

In the following, it will be described in detail how the display device provided in FIG. 9 realizes an eight-color display of black, white, red, green, blue, cyan, yellow and purple. Taking the first color as red, the second color as green, and the third color as blue as an example, when the display device displays black, the reflective liquid crystal layer 253 in the first liquid crystal element 25 can be switched to the focal cone state by the driver 254 of the first liquid crystal element 25, the reflective liquid crystal layer 263 in the second liquid crystal element 26 can be switched to the focal cone state by the driver 264 of the second liquid crystal element 26, and the reflective liquid crystal layer 273 in the third liquid crystal element 27 can be switched to the focal cone state by the driver 274 of the third liquid crystal element 27, the first liquid crystal element 25, the second liquid crystal element 26, and the third liquid crystal element 27 do not reflect corresponding colors, and external light transmits through the third liquid crystal element 27, the second liquid crystal element 26 and the first liquid crystal element 25 to reach the light absorption layer 10 and is absorbed by the light absorption layer 10, such that the device displays black. When the display device displays white, the reflective liquid crystal layer 253 in the first liquid crystal element 25 can be switched to the reflective state by the driver 254 of the first liquid crystal element 25, the reflective liquid crystal layer 263 in the second liquid crystal element 26 can be switched to the reflective state by the driver 264 of the second liquid crystal element 26, and the reflective liquid crystal layer 273 in the third liquid crystal element 27 can be switched to the reflective state by the driver 274 of the third liquid crystal element 27, the first liquid crystal element 25 reflects red light, the second liquid crystal element 26 reflects green light, the third liquid crystal element 27 reflects blue light, and a combination of the red light, the green light and the blue light displays as white. When the display device displays red, the reflective liquid crystal layer 253 of the first liquid crystal element 25 is switched to the reflective state by the driver 254 of the first liquid crystal element 25, the reflective liquid crystal layer 263 of the second liquid crystal element 26 is switched to the focal cone state by the driver 264 of the second liquid crystal element 26, the reflective liquid crystal layer 273 of the third liquid crystal element 27 is switched to the focal cone state by the driver 274 of the third liquid crystal element 27, and external light transmits through the third liquid crystal element 27 and the second liquid crystal element 26 to reach the first liquid crystal element 25, such that the first liquid crystal element 25 reflects red light. At this time, the device displays red. When the display device displays green, the reflective liquid crystal layer 253 of the first liquid crystal element 25 is switched to the focal cone state by the driver 254 of the first liquid crystal element 25, the reflective liquid crystal layer 263 of the second liquid crystal element 26 is switched to the reflective state by the driver 264 of the second liquid crystal element 26, and the reflective liquid crystal layer 273 of the third liquid crystal element 27 is switched to the focal cone state by the driver 274 of the third liquid crystal element 27, and external light transmits through the third liquid crystal element 27 to reach the second liquid crystal element 26, such that the second liquid crystal element 26 reflects green light. At this time, the device displays green. When the display device displays blue, the reflective liquid crystal layer 253 of the first liquid crystal element 25 can be switched to the focal cone state by the driver 254 of the first liquid crystal element 25, the reflective liquid crystal layer 263 of the second liquid crystal element 26 can be switched to the focal cone state by the driver 264 of the second liquid crystal element 26, the reflective liquid crystal layer 273 of the third liquid crystal element 27 can be switched to the reflective state by the driver 274 of the third liquid crystal element 27, and the third liquid crystal element 27 reflects blue light. At this time, the device displays blue. When the display device displays cyan, the reflective liquid crystal layer 253 of the first liquid crystal element 25 can be switched to the focal cone state by the driver 254 of the first liquid crystal element 25, the reflective liquid crystal layer 263 of the second liquid crystal element 26 can be switched to the reflective state by the driver 264 of the second liquid crystal element 26, the reflective liquid crystal layer 273 of the third liquid crystal element 27 can be switched to the reflective state by the driver 274 of the third liquid crystal element 27, the third liquid crystal element 27 reflects blue light, the second liquid crystal element 26 reflects green light, and a combination of the green light and the blue light displays as cyan. When the display device displays yellow, the reflective liquid crystal layer 253 of the first liquid crystal element 25 can be switched to the reflective state by the driver 254 of the first liquid crystal element 25, the reflective liquid crystal layer 263 of the second liquid crystal element 26 can be switched to the reflective state by the driver 264 of the second liquid crystal element 26, the reflective liquid crystal layer 273 of the third liquid crystal element 27 can be switched to the focal cone state by the driver 274 of the third liquid crystal element 27, the first liquid crystal element 25 reflects red light, the second liquid crystal element 26 reflects green light, and a combination of the red light and the green light displays as yellow. When the display device displays purple, the reflective liquid crystal layer 253 of the first liquid crystal element 25 can be switched to the reflective state by the driver 254 of the first liquid crystal element 25, the reflective liquid crystal layer 263 of the second liquid crystal element 26 can be switched to the focal cone state by the driver 264 of the second liquid crystal element 26, the reflective liquid crystal layer 273 of the third liquid crystal element 27 can be switched to the reflective state by the driver 274 of the third liquid crystal element 27, the first liquid crystal element 25 reflects red light, the third liquid crystal element 27 reflects blue light, and a combination of the red light and the blue light displays as purple. The display device provided in FIG. 9 of the present disclosure can realize an eight-color display of black, white, red, green, blue, cyan, yellow and purple in the above manner, realize the color display of the display device, and improve the display effect of the display device.

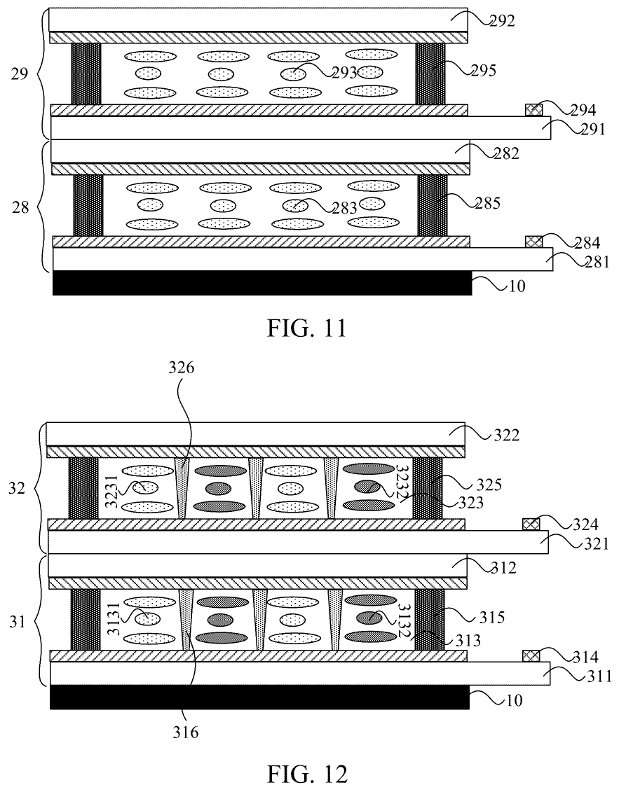

In an exemplary implementation mode, FIG. 11 is a fourth schematic diagram of a structure of a display device provided by an exemplary implementation mode. As shown in FIG. 11, the at least two liquid crystal elements may include a first liquid crystal element 28 and a second liquid crystal element 29. The first liquid crystal element 28 includes a first substrate 281, a second substrate 282, a reflective liquid crystal layer 283, a driver 284, and a sealant 285. The second liquid crystal element 29 includes a first substrate 291, a second substrate 292, a reflective liquid crystal layer 293, a driver 294, and a sealant 295. Herein, when the reflective liquid crystal layer 283 of the first liquid crystal element 28 is in the reflective state, the first liquid crystal element 28 reflects light of a first color, and when the reflective liquid crystal layer 293 of the second liquid crystal element 29 is in the reflective state, the second liquid crystal element 29 reflects light of a second color, wherein the first color light is one of the left-handed polarized light or right-handed polarized light, the second color light is the other of the left-handed polarized light or the right-handed polarized light, and the first color and the second color are the same.

In an exemplary implementation mode, in the display device provided in FIG. 11, a distance between a first electrode and a second electrode of any sub-pixel in the first liquid crystal element 28 is the same as a distance between a first electrode and a second electrode of any sub-pixel in the second liquid crystal element 29.

In an exemplary implementation mode, the first liquid crystal element 28 may be located on a side of the second liquid crystal element 29 close to the light absorption layer 10, or may be on a side of the second liquid crystal element 29 away from the light absorption layer 10. FIG. 11 illustrates an example in which the first liquid crystal element 28 may be located on the side of the second liquid crystal element 29 close to the light absorption layer 10.

In an exemplary implementation mode, in the display device provided in FIG. 11, the first color light ray is one of left-handed polarized light or right-handed polarized light, and the second color light ray is the other of the left-handed polarized light or the right-handed polarized light.

In an exemplary implementation mode, a bonding deviation of the first liquid crystal element 28 and the second liquid crystal element 29 is less than or equal to 5 microns. Exemplarily, the first liquid crystal element 28 and the second liquid crystal element 29 may be bonded using a high-precision bonding apparatus. If the bonding deviation of the first liquid crystal element 28 and the second liquid crystal element 29 is less than or equal to 5 microns, light leakage, moire pattern and rainbow pattern phenomena of the display device can be avoided, and the display effect of the display device can be improved.

In an exemplary implementation mode, FIG. 12 is a fifth schematic diagram of a structure of a display device provided by an exemplary implementation mode. As shown in FIG. 12, the at least two liquid crystal elements may include a first liquid crystal element 31 and a second liquid crystal element 32. The first liquid crystal element 31 includes a first substrate 311, a second substrate 312, a reflective liquid crystal layer 313, a driver 314, and a sealant 315. The second liquid crystal element 32 includes a first substrate 321, a second substrate 322, a reflective liquid crystal layer 323, a driver 324, and a sealant 325.

In an exemplary implementation mode, as shown in FIG. 12, liquid crystals in the first liquid crystal element 31 include first liquid crystals 3131 and second liquid crystals 3132, and liquid crystals in the second liquid crystal element 32 includes first liquid crystals 3231 and second liquid crystals 3232. The first liquid crystals 3131 in the first liquid crystal element 31 and the first liquid crystals 3231 in the second liquid crystal element 32 are liquid crystals of a first color, and the second liquid crystals 3132 in the first liquid crystal element 31 and the second liquid crystals 3232 in the second liquid crystal element 32 are liquid crystals of a second color.

In an exemplary implementation mode, as shown in FIG. 12, the first liquid crystals 3131 and the second liquid crystals 3132 in the first liquid crystal element 31 are left-handed cholesteric phase liquid crystals, the first liquid crystals 3231 and the second liquid crystals 3232 in the second liquid crystal element 32 are right-handed cholesteric phase liquid crystal, or the first liquid crystals 3131 and the second liquid crystals 3132 in the first liquid crystal element 31 are the right-handed cholesteric phase liquid crystals, the first liquid crystals 3231 and the second liquid crystals 3232 in the second liquid crystal element 32 are the left-handed cholesteric phase liquid crystal, or the first liquid crystals 3131 in the first liquid crystal element 31 are the left-handed cholesteric phase liquid crystals, the second liquid crystals 3132 in the first liquid crystal element 31 are the right-handed cholesteric phase liquid crystals, the first liquid crystals 3231 in the second liquid crystal element 32 are the right-handed cholesteric phase liquid crystals, the second liquid crystals 3232 in the second liquid crystal element 32 are the left-handed cholesteric phase liquid crystals, or the first liquid crystals 3131 in the first liquid crystal element 31 are the right-handed cholesteric phase liquid crystals, the second liquid crystals 3132 in the first liquid crystal element 31 are the left-handed cholesteric phase liquid crystals, the first liquid crystals 3231 in the second liquid crystal element 32 are the left-handed cholesteric phase liquid crystals, the second liquid crystals 3232 in the second liquid crystal element 32 are the right-handed cholesteric phase liquid crystals.

In an exemplary implementation mode, as shown in FIG. 12, the liquid crystals of the first color and the liquid crystals of the second color are liquid crystals of different colors, and a combined color of a color of light reflected by the liquid crystals of the first color and a color of light reflected by the liquid crystals of the second color is white. Exemplarily, the liquid crystals of the first color and the liquid crystals of the second color are either red cholesteric phase liquid crystals or cyan cholesteric phase liquid crystals, or the liquid crystals of the first color and the liquid crystals of the second color are either yellow cholesteric phase liquid crystals or blue cholesteric phase liquid crystals.

In an exemplary implementation mode, the present disclosure can realize four-color display of the display device by providing two different colors of cholesteric phase liquid crystal in a plurality of liquid crystal elements, and improves the display effect of the display device.

In an exemplary implementation mode, as shown in FIG. 12, a distance between a first electrode and a second electrode of a sub-pixel where a first liquid crystal 3131 in the first liquid crystal element 31 is located is the same as a distance between a first electrode and a second electrode of a sub-pixel where a first liquid crystal 3231 in the second liquid crystal element 32 is located, and a distance between a first electrode and a second electrode of a sub-pixel where a second liquid crystal 3132 in the first liquid crystal element 31 is located is the same as a distance between a first electrode and a second electrode of a sub-pixel where a second liquid crystal 3232 in the second liquid crystal element 32 is located.

In an exemplary implementation mode, as shown in FIG. 12, when the liquid crystals of the first color and the liquid crystals of the second color are either red cholesteric phase liquid crystals or cyan cholesteric phase liquid crystals, a distance between a first electrode and a second electrode of a sub-pixel where a liquid crystal reflecting the red light is located is larger than a distance between a first electrode and a second electrode of a sub-pixel where a liquid crystal reflecting the cyan light is located.

In an exemplary implementation mode, as shown in FIG. 12, when the liquid crystals of the first color and the liquid crystals of the second color are one of the yellow cholesteric phase liquid crystals and the blue cholesteric phase liquid crystals, and a distance between a first electrode and a second electrode of a sub-pixel where a liquid crystal reflecting the yellow light is located is larger than a distance between a first electrode and a second electrode of a sub-pixel where a liquid crystal reflecting the blue light is located.

In an exemplary implementation mode, as shown in FIG. 12, an orthographic projection of a sub-pixel including a first liquid crystal 3131 in the first liquid crystal element 31 on the light absorption layer is at least partially overlapped with an orthographic projection of a sub-pixel including a first liquid crystal 3231 in the second liquid crystal element 32 on the light absorption layer, and the orthographic projection of the sub-pixel including the first liquid crystal 3131 in the first liquid crystal element 31 on the light absorption layer is not overlapped with an orthographic projection of a sub-pixel including a second liquid crystal 3232 on the light absorption layer.

In an exemplary implementation mode, as shown in FIG. 12, an orthographic projection of a sub-pixel including a second liquid crystal 3132 in the first liquid crystal element 31 on the light absorption layer is at least partially overlapped the orthographic projection of the sub-pixel including the second liquid crystal 3232 in the second liquid crystal element 32 on the light absorption layer, and the orthographic projection of the sub-pixel including the second liquid crystal 3132 in the first liquid crystal element 31 on the light absorption layer is not overlapped with the orthographic projection of the sub-pixel including the first liquid crystal 3231 in the second liquid crystal element 32 on the light absorption layer.

In an exemplary implementation mode, as shown in FIG. 12, a liquid crystal element includes an isolation structure disposed between the first substrate and the second substrate. The first liquid crystal element 31 includes an isolation structure 316, and the second liquid crystal element includes an isolation structure 326.

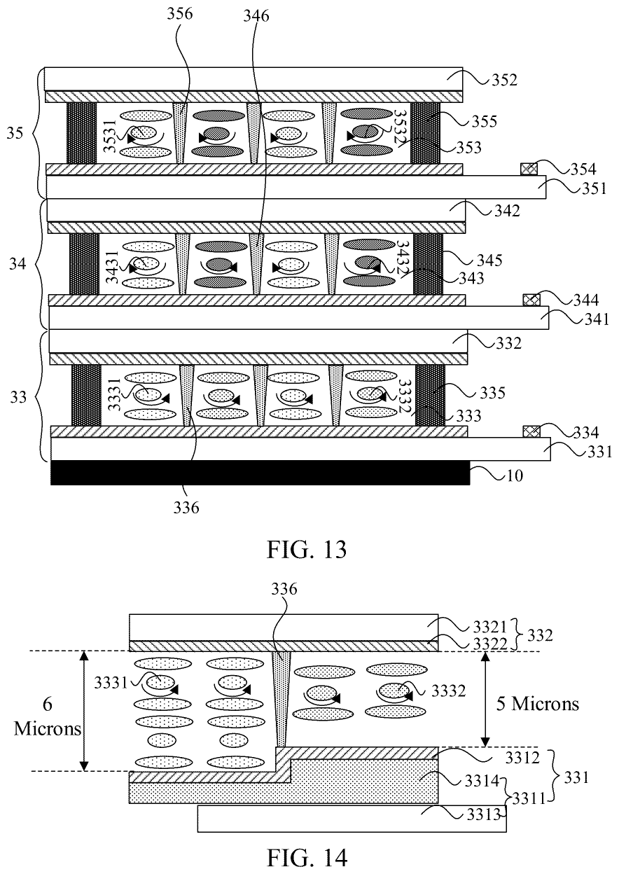

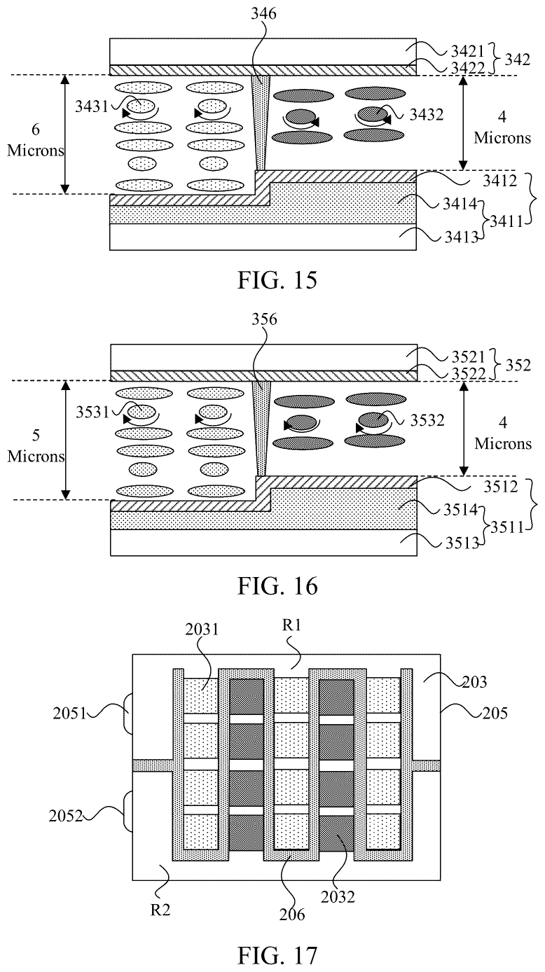

In an exemplary implementation mode, FIG. 13 is a sixth schematic diagram of a structure of a display device provided by an exemplary implementation mode, FIG. 14 is a partial schematic diagram of a first liquid crystal element in FIG. 13, FIG. 15 is a partial schematic diagram of a second liquid crystal element in FIG. 13, and FIG. 16 is a partial schematic diagram of a third liquid crystal element in FIG. 13. As shown in FIGS. 13 to 16, the display device includes a light absorption layer 10 and a first liquid crystal element 33, a second liquid crystal element 34, and a third liquid crystal element 35 stacked on the light absorption layer 10. Herein, the first liquid crystal element 33 includes a first substrate 331, a second substrate 332, a reflective liquid crystal layer 333, a driver 334, a sealant 335, and an isolation structure 336. The second liquid crystal element 34 includes a first substrate 341, a second substrate 342, a reflective liquid crystal layer 343, a driver 344, a sealant 345, and an isolation structure 346. The third liquid crystal element 35 includes a first substrate 351, a second substrate 352, a reflective liquid crystal layer 353, a driver 354, a sealant 355, and an isolation structure 356. The reflective liquid crystal layers in the first liquid crystal element to the third liquid crystal element include first liquid crystals and second liquid crystals.

In an exemplary implementation mode, in the display device provided in FIG. 13, first liquid crystals 3331 in the first liquid crystal element 33 and first liquid crystals 3431 in the second liquid crystal element 34 are liquid crystals of the first color, second liquid crystals 3332 in the first liquid crystal element 33 and first liquid crystals 3531 in the third liquid crystal element 35 are liquid crystals of the second color, and second liquid crystals 3432 in the second liquid crystal element 34 and second liquid crystals 3532 in the third liquid crystal element 35 are liquid crystals of the third color. The liquid crystals of the first color, the liquid crystals of the second color and the liquid crystals of the third color are liquid crystals of different colors, and a combined color of light reflected by the liquid crystals of the first color, light reflected by the liquid crystals of the second color, and light reflected by the liquid crystals of the third color is white.

In an exemplary implementation mode, the combined color mixing effect is mainly viewed by the human eye, and the blue cholesteric phase liquid crystals are placed at a position far away from the light absorption layer, and the red cholesteric phase liquid crystal is placed on the lower side. On the one hand, placing the blue cholesteric phase liquid crystals at a lower position can reduce an influence of the display device itself on the reflectivity; in addition, blue light has a short wavelength, and when viewed from a side angle, it tends to exhibit color shift toward longer wavelengths due to an increased optical path. Placing the liquid crystal element where the blue cholesteric phase liquid crystals is located far away from the light absorption layer can minimize the optical path of reflected light, thereby reducing color shift.

In an exemplary implementation mode, in the display device provided in FIG. 13, either the first liquid crystals in the first liquid crystal element 33 or the first liquid crystals in the second liquid crystal element 34 are left-handed cholesteric phase liquid crystals, the others of the first liquid crystals in the first liquid crystal element 33 and the first liquid crystals in the second liquid crystal element 34 are right-handed cholesteric phase liquid crystals, either the second liquid crystals in the first liquid crystal element 33 or the first liquid crystals in the third liquid crystal element 35 are the left-handed cholesteric phase liquid crystals, either the second liquid crystals in the first liquid crystal element 33 or the first liquid crystals in the third liquid crystal element 35 are the right-handed cholesteric phase liquid crystals, either the second liquid crystals in the second liquid crystal element 34 or the second liquid crystals in the third liquid crystal element 35 are the left-handed cholesteric phase liquid crystals, the others of the second liquid crystals in the second liquid crystal element 34 and the second liquid crystals in the third liquid crystal element 35 are the right-handed cholesteric phase liquid crystals, the first liquid crystals and the second liquid crystals in the first liquid crystal element 33 are the left-handed cholesteric phase liquid crystals or the right-handed cholesteric phase liquid crystals, either the first liquid crystals or the second liquid crystals in the second liquid crystal element 34 are the left-handed cholesteric phase liquid crystals, the others of the first liquid crystals and the second liquid crystals in the second liquid crystal element 34 are the right-handed cholesteric phase liquid crystals, and the first liquid crystals and the second liquid crystals in the third liquid crystal element 35 are the left-handed cholesteric phase liquid crystals or the right-handed cholesteric phase liquid crystals. In an exemplary implementation mode, FIGS. 13 to 16 show that the first liquid crystals 3331 and the second liquid crystals 3332 in the first liquid crystal element 33 are the right-handed cholesteric phase liquid crystals, the first liquid crystals 3431 in the second liquid crystal element 34 are the left-handed cholesteric phase liquid crystals, the second liquid crystals 3432 in the second liquid crystal element 34 are the right-handed cholesteric phase liquid crystals, and the first liquid crystals 3531 and the second liquid crystals 3532 in the third liquid crystal element 35 are the right-handed cholesteric phase liquid crystal. The display device provided in FIG. 13 includes the liquid crystals of the first color that can reflect left-handed polarized light, the liquid crystals of the first color that can reflect right-handed polarized light, the liquid crystals of the second color that can reflect the left-handed polarized light, the liquid crystals of the second color that can reflect the right-handed polarized light, the liquid crystals of the third color that can reflect the left-handed polarized light, and the liquid crystals of the third color that can reflect the right-handed polarized light. That is, liquid crystals of each color using a combination of the left-handed cholesteric phase liquid crystal and the right-handed cholesteric phase liquid crystal, which can ensure the light utilization efficiency of the display device, improve the reflectivity of the display device for multiple colors, and also ensure the color display of the display device.

In an exemplary implementation mode, as shown in FIGS. 14 to 16, a distance between a first electrode and a second electrode of a sub-pixel where a first liquid crystal in the first liquid crystal element is located is the same as a distance between a first electrode and a second electrode of a sub-pixel where a first liquid crystal in the second liquid crystal element is located; a distance between a first electrode and a second electrode of a sub-pixel where a second liquid crystal in the first liquid crystal element is located is the same as a distance between a first electrode and a second electrode of a sub-pixel where a first liquid crystal in the third liquid crystal element is located; and a distance between a first electrode and a second electrode of a sub-pixel where a second liquid crystal in the second liquid crystal element is located is the same as a distance between a first electrode and a second electrode of a sub-pixel where a second liquid crystal in the third liquid crystal element is located.

In an exemplary implementation mode, the liquid crystals of the first color, the liquid crystals of the second color, and the liquid crystals of the third color are one of red cholesteric phase liquid crystals, green cholesteric phase liquid crystals, and blue cholesteric phase liquid crystals.

In an exemplary implementation mode, as shown in FIGS. 14 to 16, a distance between a first electrode and a second electrode of a sub-pixel where a liquid crystal of the first color is located is larger than a distance between a first electrode and a second electrode of a sub-pixel where a liquid crystal of the second color is located, and the distance between the first electrode and the second electrode of the sub-pixel where the liquid crystal of the second color is located is larger than a distance between a first electrode and a second electrode of a sub-pixel where a liquid crystal of the third color is located.

In an exemplary implementation mode, the distance between the first electrode and the second electrode of the sub-pixel where the liquid crystal of the first color is located ranges from 5.8 microns to 6.2 microns. Exemplarily, the distance between the first electrode and the second electrode of the sub-pixel where the liquid crystal of the first color is located is 6 microns.

In an exemplary implementation mode, the distance between the first electrode and the second electrode of the sub-pixel where the liquid crystal of the second color is located ranges from 4.8 microns to 5.2 microns. Exemplarily, the distance between the first electrode and the second electrode of the sub-pixel where the liquid crystal of the second color is located is 5 microns.

In an exemplary implementation mode, the distance between the first electrode and the second electrode of the sub-pixel where the liquid crystal of the third color is located ranges from 3.8 microns to 4.2 microns. Exemplarily, the distance between the first electrode and the second electrode of the sub-pixel where the liquid crystal of the third color is located is 4 microns.

In the following, it will be described in detail how the display device provided in FIG. 13 realizes eight-color display of black, white, red, green, blue, cyan, yellow and purple. Taking the first color as red, the second color as green, and the third color as blue as an example, when the display device displays black, the first liquid crystals and the second liquid crystals in the reflective liquid crystal layer 333 in the first liquid crystal element 33 can be switched to the focal cone state by the driver 334 of the first liquid crystal element 33, the first liquid crystals and the second liquid crystals in the reflective liquid crystal layer 343 in the second liquid crystal element 34 can be switched to the focal cone state by the driver 344 of the second liquid crystal element 34, and the first liquid crystals and the second liquid crystals in the reflective liquid crystal layer 353 in the third liquid crystal element 35 can be switched to the focal cone state by the driver 354 of the third liquid crystal element 35, the first liquid crystal element 33, the second liquid crystal element 34, and the third liquid crystal element 35 do not reflect corresponding colors, and external light transmits through the third liquid crystal element 35, the second liquid crystal element 34 and the first liquid crystal element 33 to reach the light absorption layer 10 and is absorbed by the light absorption layer 10, such that the device displays black. When the display device displays white, the first liquid crystals and the second liquid crystals in the reflective liquid crystal layer 333 in the first liquid crystal element 33 can be switched to the reflective state by the driver 334 of the first liquid crystal element 33, the first liquid crystals and the second liquid crystals in the reflective liquid crystal layer 343 in the second liquid crystal element 34 can be switched to the reflective state by the driver 344 of the second liquid crystal element 34, and the first liquid crystals and the second liquid crystals in the reflective liquid crystal layer 353 in the third liquid crystal element 35 can be switched to the reflective state by the driver 354 of the third liquid crystal element 35, the first liquid crystal element 33 reflects the red light and the green light, the second liquid crystal element 34 reflects the red light and the blue light, and the third liquid crystal element 35 reflects the blue light and the green light, and a combination of the red light, the green light, and the blue light displays white. When the display device displays red, the first liquid crystal and the second liquid crystal in the reflective liquid crystal layer 333 in the first liquid crystal element 33 can be respectively switched to the reflective state and the focal cone state by the driver 334 of the first liquid crystal element 33, the first liquid crystal and the second liquid crystal in the reflective liquid crystal layer 343 in the second liquid crystal element 34 can be respectively switched to the reflective state and the focal cone state by the driver 344 of the second liquid crystal element 34, and the first liquid crystals and the second liquid crystals in the reflective liquid crystal layer 353 in the third liquid crystal element 35 can be switched to the focal cone state by the driver 354 of the third liquid crystal element 35, and external light transmits through the third liquid crystal element 35 to reach the second liquid crystal element 34, such that the first liquid crystal element 33 and the second liquid crystal element 34 reflect the red light. At this time, the device displays red. When the display device displays green, the first liquid crystal and the second liquid crystal in the reflective liquid crystal layer 333 in the first liquid crystal element 33 can be respectively switched to the focal cone state and the reflective state by the driver 334 of the first liquid crystal element 33, the first liquid crystals and the second liquid crystals in the reflective liquid crystal layer 343 in the second liquid crystal element 34 can be switched to the focal cone state by the driver 344 of the second liquid crystal element 34, and the first liquid crystal and the second liquid crystal in the reflective liquid crystal layer 353 in the third liquid crystal element 35 can be respectively switched to the reflective state and the focal cone state by the driver 354 of the third liquid crystal element 35, such that the first liquid crystal element 33 and the third liquid crystal element 35 reflects the green light. At this time, the device displays green. When the display device displays blue, the first liquid crystals and the second liquid crystals in the reflective liquid crystal layer 333 in the first liquid crystal element 33 can be switched to the focal cone state by the driver 334 of the first liquid crystal element 33, the first liquid crystal and the second liquid crystal in the reflective liquid crystal layer 343 in the second liquid crystal element 34 can be respectively switched to the focal cone state and the reflective state by the driver 344 of the second liquid crystal element 34, and the first liquid crystal and the second liquid crystal in the reflective liquid crystal layer 353 in the third liquid crystal element 35 can be respectively switched to the focal cone state and the reflective state by the driver 354 of the third liquid crystal element 35, such that the second liquid crystal element 34 and the third liquid crystal element 35 reflects the blue light. At this time, the device displays blue. When the display device displays cyan, the first liquid crystal and the second liquid crystal in the reflective liquid crystal layer 333 in the first liquid crystal element 33 can be respectively switched to the focal cone state and the reflective state by the driver 334 of the first liquid crystal element 33, the first liquid crystal and the second liquid crystal in the reflective liquid crystal layer 343 in the second liquid crystal element 34 can be respectively switched to the focal cone state and the reflective state by the driver 344 of the second liquid crystal element 34, and the first liquid crystals and the second liquid crystals in the reflective liquid crystal layer 353 in the third liquid crystal element 35 can be switched to the reflective state by the driver 354 of the third liquid crystal element 35, such that the first liquid crystal element 33 reflects the green light, the second liquid crystal element 34 reflects the blue light, the third liquid crystal element 35 reflects the blue light and the green light, and a combination of the green light and the blue light displays cyan. When the display device displays yellow, the first liquid crystals and the second liquid crystals in the reflective liquid crystal layer 333 in the first liquid crystal element 33 can be switched to the reflective state by the driver 334 of the first liquid crystal element 33, the first liquid crystal and the second liquid crystal in the reflective liquid crystal layer 343 in the second liquid crystal element 34 can be respectively switched to the reflective state and the focal cone state by the driver 344 of the second liquid crystal element 34, and the first liquid crystal and the second liquid crystal in the reflective liquid crystal layer 353 in the third liquid crystal element 35 can be respectively switched to the reflective state and the focal cone state by the driver 354 of the third liquid crystal element 35, such that the first liquid crystal element 33 reflects the red light, the second liquid crystal element 34 reflects the red light, the third liquid crystal element 35 reflects the green light, and a combination of the red light and the green light displays yellow. When the display device displays purple, the first liquid crystal and the second liquid crystal in the reflective liquid crystal layer 333 in the first liquid crystal element 33 can be respectively switched to the reflective state and the focal cone state by the driver 334 of the first liquid crystal element 33, the first liquid crystals and the second liquid crystals in the reflective liquid crystal layer 343 in the second liquid crystal element 34 can be switched to the reflective state by the driver 344 of the second liquid crystal element 34, and the first liquid crystal and the second liquid crystals in the reflective liquid crystal layer 353 in the third liquid crystal element 35 can be respectively switched to the focal cone state and the reflective state by the driver 354 of the third liquid crystal element 35, such that the first liquid crystal element 33 reflects the red light, the second liquid crystal element 34 reflects the red light and the blue light, the third liquid crystal element 35 reflects the blue light, and a combination of the red light and the blue light displays purple. The display device provided in FIG. 13 of the present disclosure can realize the eight-color display of black, white, red, green, blue, cyan, yellow and purple in the above manner, realize the color display of the display device, and improve the display effect of the display device.

FIG. 17 is a top view of a liquid crystal element. As shown in FIG. 17, the isolation structure 206 is configured to separate first liquid crystals 2031 and second liquid crystals 2032; the isolation structure 206 divides a liquid crystal cell into a first area R1 and a second area R2, the first area R1 and the second area R2 are independent of each other, and the sealant 205 is provided with a first crystal filling port 2051 configured to fill first liquid crystals 2031 into one of the first area R1 and the second area R2 of the liquid crystal cell and a second crystal filling port 2052 configured to fill second liquid crystals 2032 into the other area of the first area R1 and the second area R2 of the liquid crystal cell. The liquid crystals in the first area are communicated with each other, and the liquid crystals in the second area are communicated with each other. The isolation structure in FIG. 17 may be any of the isolation structures shown in FIGS. 12 and 13.

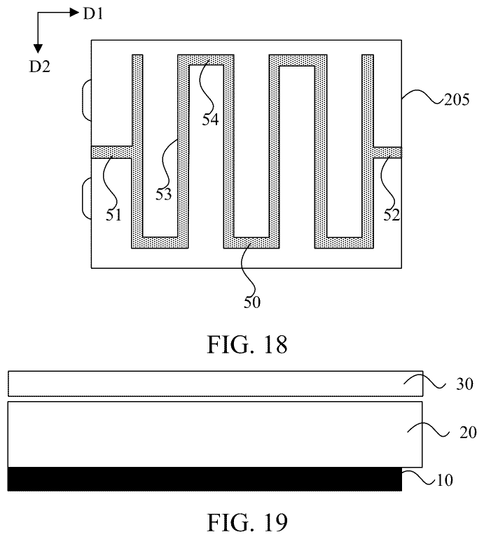

FIG. 18 is a schematic diagram of a structure of an isolation structure. In an exemplary implementation mode, as shown in FIG. 18, the isolation structure 50 includes a first connection portion 51, a second connection portion 52, N third connection portions 53, and N−1 fourth connection portions 54, and N is a positive integer greater than or equal to 2. FIG. 18 is illustrated by taking N=6 as an example.

In an exemplary implementation mode, as shown in FIG. 18, the first connection portion 51, the second connection portion 52, and the fourth connection portions 54 extend in the first direction D1, the third connection portions 53 extend in the second direction D2, and the first direction D1 and the second direction D2 intersect.

In an exemplary implementation mode, as shown in FIG. 18, one end of the first connection portion 51 is connected with a middle portion of a first inner wall of the sealant 205, the other end of the first connection portion 51 is connected with a middle portion of a first third connection portion 53, one end of the first third connection portion 53 is connected with one end of a first fourth connection portion 54, the other end of the first fourth connection portion 54 is connected with one end of a second third connection portion 53, the other end of an i-th third connection portion 53 is connected with one end of an i-th fourth connection portion 54, the other end of the i-th fourth connection portion 54 is connected with one end of an (i+1)-th third connection portion 53, the other end of the second connection portion 52 is connected with a middle portion of a second inner wall of the sealant 205, and the other end of the second connection portion 52 is connected with a middle portion of an N-th third connection portion 53; the first inner wall and the second inner wall are disposed opposite each other, and 2≤i<N−1.

In an exemplary implementation mode, as shown in FIG. 18, the third connection portion 53 and the fourth connection portion 54 form a “ [symbol] ”-shaped structure, which can increase the space in which the liquid crystals are located, and further improve the display effect of the display device.

In an exemplary implementation mode, as shown in FIG. 18, a length of a third connection portion 53 in the second direction D2 is larger than a length of any one of the first connection portion 51, the second connection portion 52, and a fourth connection portion 54 in the first direction d1.

In an exemplary implementation mode, the isolation structure may be an adhesive isolation column retaining wall.

In an exemplary implementation mode, FIG. 19 is a schematic diagram of another structure of a display device. As shown in FIG. 19, the display device includes a light absorption layer 10, a liquid crystal element layer 20, and a protective cover plate 30. The protective cover plate 30 is located on a side of the liquid crystal element layer 20 away from the light absorption layer 10.

In an exemplary implementation mode, since the free energy of the planar texture state of the cholesteric phase liquid crystal is low and the free energy of the focal cone texture state or the deshelical state of the cholesteric phase liquid crystal is high, the cholesteric phase liquid crystal in the focal cone texture state or the deshelical state is changed to the planar texture state under the action of external pressure, thus, the pressure resistance of the display device is not high. The present disclosure provides a protective cover plate on the liquid crystal element layer, with a spacing between the cover plate and the liquid crystal element layer. This spacing enhances the display device's pressure resistance.

In an exemplary implementation mode, a distance between the protective cover plate 30 and the liquid crystal element layer 20 ranges from 1 mm to 1.5 mm. Exemplarily, the distance between the protective cover plate 30 and the liquid crystal element layer 20 may be 1.2 mm. In an exemplary implementation mode, when the distance between the protective cover plate 30 and the liquid crystal element layer 20 is 1.2 mm, a force that the display device can withstand can reach 45 Newtons.

In an exemplary implementation mode, when the distance between the protective cover plate 30 and the liquid crystal element layer 20 is less than 1.2 mm, the force that the display device can withstand is less than 40 Newtons, and when the distance between the protective cover plate 30 and the liquid crystal element layer 20 is greater than 1.2 mm, a light loss of the display device is large, and a reflectivity attenuation is as high as 10%. Therefore, the distance between the protective cover plate 30 and the liquid crystal element layer 20 of 1.2 mm ensures the display effect of the display device on the premise of ensuring the pressure resistance of the display device.

In an exemplary implementation mode, the protective cover plate may be a glass cover plate.

In an exemplary implementation, in the present disclosure, an AG treatment may be performed on the surface of the glass cover plate, so that the glass cover plate has a haze ranging from about 10% to 15%, and the treatment on the glass cover plate in the present disclosure can prevent specular reflection on the surface of the glass cover plate, and can improve display effect of a display device and improve visual experience of human eyes.

In an exemplary implementation mode, liquid crystals in a liquid crystal element that reflects left-handed polarized light in the reflective state is doped with a left-handed chiral agent, thereby achieving reflection of the left-handed polarized light by the liquid crystal element.

In an exemplary implementation mode, liquid crystals in the liquid crystal element that reflects right-handed polarized light in the reflective state are doped with a right-handed chiral agent, thereby achieving reflection of the right-handedly polarized light by the liquid crystal element.

In an exemplary implementation mode, the reflective liquid crystal layer in the liquid crystal element includes a cholesteric phase liquid crystal and an acrylic polymer, wherein a content of the acrylic polymer ranges from 3% to 5%. Exemplarily, the content of the acrylic polymer may be 4%.

In an exemplary implementation mode, the acrylic polymer is added to the cholesteric phase liquid crystal in the liquid crystal element, and the cholesteric phase liquid crystal and the acrylic polymer are polymerized by ultraviolet irradiation, thereby forming a helical polymer skeleton, thereby making the state of the reflective liquid crystal layer relatively stable, and further improving the pressure resistance of the display device.

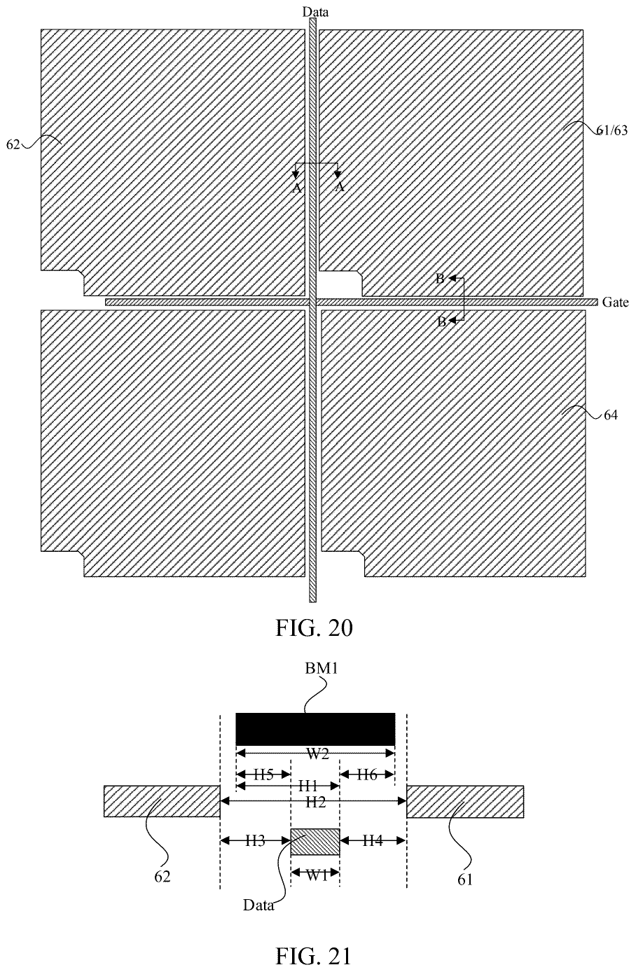

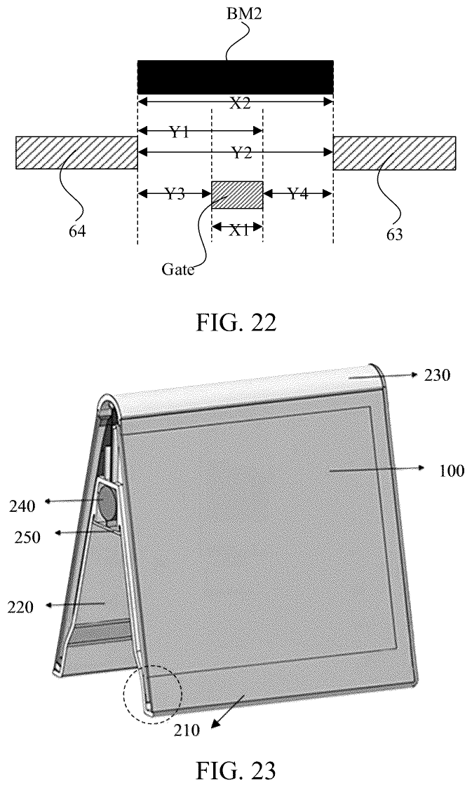

FIG. 20 is another top view of a liquid crystal element, FIG. 21 is a cross-sectional diagram taken along an A-A direction in FIG. 20, and FIG. 22 is a cross-sectional diagram taken along a B-B direction in FIG. 20. In order to clearly explain the structure of the liquid crystal element, a black matrix layer is not drawn in FIG. 20, but actually the black matrix layer exists and covers the scan signal lines Gate and the data signal lines Data. As shown in FIGS. 20 to 22, 61 and 62 respectively refer to first electrodes of two sub-pixels adjacent to both sides of a data signal line Data, 63 and 64 respectively refer to first electrodes of two sub-pixels adjacent to both sides of a scan signal line Gate, and the black matrix layer includes a first black matrix structure BM1 and a second black matrix structure BM2, wherein an orthographic projection of the first black matrix structure BM1 on the light absorption layer is at least partially overlapped with an orthographic projection of the data signal line Data on the light absorption layer, and an orthographic projection of the second black matrix structure BM2 on the light absorption layer is at least partially overlapped with an orthographic projection of the scan signal line Gate on the light absorption layer.

In an exemplary implementation mode, as shown in FIGS. 21 and 22, a distance between the orthographic projection of the first black matrix structure BM1 on the light absorption layer and an orthographic projection of a first electrode of any one of two adjacent sub-pixels located on both sides of the data signal line Data on the light absorption layer is a first distance, a distance between the orthographic projection of the second black matrix structure BM2 on the light absorption layer and an orthographic projection of a first electrode of any one of two adjacent sub-pixels located on both sides of the scan signal line Gate on the light absorption layer is a second distance, and the first distance is larger than the second distance.

In an exemplary implementation mode, as shown in FIGS. 21 and 22, the first distance may be 0.5 microns and the second distance may be 0 microns.

In an exemplary implementation mode, as shown in FIG. 21, a distance H1 between an orthographic projection of a boundary of the data signal line Data close to one of the two adjacent sub-pixels located on both sides of the data signal line Data on the light absorption layer and an orthographic projection of a boundary of the first black matrix structure BMI close to the other of the two adjacent sub-pixel located on both sides of the data signal line Data on the light absorption layer is larger than a bonding deviation of adjacent liquid crystal elements.

In an exemplary implementation mode, H1 may be in a range of 6 microns, and in the present disclosure, by setting H1 to be larger than the bonding deviation of the adjacent liquid crystal elements, light leakage, moire pattern, and rainbow pattern phenomena in the display device can be avoided, and the display effect of the display device can be improved.

In an exemplary implementation mode, as shown in FIG. 22, a distance Y1 between an orthographic projection of a boundary of the scan signal line Gate close to one of the two adjacent sub-pixels located on both sides of the scan signal line Gate on the light absorption layer and an orthographic projection of a boundary of the second black matrix structure BM2 close to the other of the two adjacent sub-pixel located on both sides of the scan signal line Gate on the light absorption layer is larger than the bonding deviation of the adjacent liquid crystal elements.

In an exemplary implementation mode, Y1 may be in a range of 7 microns, and in the present disclosure, by setting Y1 to be larger than the bonding deviation of the adjacent liquid crystal elements, light leakage, moire pattern, and rainbow pattern phenomena in the display device can be avoided, and the display effect of the display device can be improved.

In an exemplary implementation mode, as shown in FIG. 21, a line width W1 of the data signal line Data is in a range of 3 microns.

In an exemplary implementation mode, as shown in FIG. 21, a line width W2 of the first black matrix structure BM1 is in a range of 9 microns.

In an exemplary implementation mode, as shown in FIG. 21, a distance H2 between the first electrodes of the two adjacent sub-pixels located on both sides of the data signal line Data is in a range of 10 microns.

In an exemplary implementation mode, as shown in FIG. 21, a distance H3 between the orthographic projection of the data signal line Data on the light absorption layer and a first electrode of one of the two adjacent sub-pixels located on both sides of the data signal line Data is in a range of 3.5 microns, and a distance H4 between the orthographic projection of the data signal line Data on the light absorption layer and a first electrode of the other of the two adjacent sub-pixels located on both sides of the data signal line Data is in a range of 3.5 microns.

In an exemplary implementation mode, as illustrated in FIG. 21, a distance H5 between the orthographic projection of the boundary of the data signal line Data close to one of the two adjacent sub-pixels located on both sides of the data signal line Data on the light absorption layer and the orthographic projection of the boundary of the first black matrix structure BM1 close to one of the two adjacent sub-pixels located on both sides of the data signal line Data on the light absorption layer is in a range of 3 microns. A distance H6 between the orthographic projection of the boundary of the data signal line Data close to the other of the two adjacent sub-pixels located on both sides of the data signal line Data on the light absorption layer and the orthographic projection of the boundary of the first black matrix structure BM1 close to the other of the two adjacent sub-pixels located on both sides of the data signal line Data on the light absorption layer is in a range of 3 microns.

In an exemplary implementation mode, as shown in FIG. 22, a line width X1 of the scan signal line Gate is in a range of 4 microns.

In an exemplary implementation mode, as shown in FIG. 22, a line width X2 of the second black matrix structure BM2 is in a range of 10 microns.

In an exemplary implementation mode, as shown in FIG. 22, a distance Y2 between the first electrodes of the two adjacent sub-pixels located on both sides of the scan signal line Gate is in a range of 10 microns.

In an exemplary implementation mode, as shown in FIG. 22, a distance Y3 between the orthographic projection of the scan signal line Gate on the light absorption layer and a first electrode of one of the two adjacent sub-pixels located on both sides of the scan signal line Gate is in a range of 3 microns, and a distance Y4 between the orthographic projection of the scan signal line Gate on the light absorption layer and a first electrode of the other of the two adjacent sub-pixels located on both sides of the scan signal line Gate is in a range of 3 microns.

The present disclosure also provides a driving method of a display device, configured for driving the display device. The display device is the display device provided in any one of the foregoing embodiments, implementation principle and implementation effects of which are similar to those of the display device in any one of the foregoing embodiments, and will not be repeated here.

The driving method of the display device includes: providing signals to first substrates and second substrates of at least two liquid crystal elements such that reflective liquid crystal layers of the at least two liquid crystal elements switch between the focal cone state and the reflective state.

In an exemplary implementation mode, the at least two liquid crystal elements include a first liquid crystal element that reflects light of a first color and a second liquid crystal element that reflects light of a second color, and the first color and the second color are different; providing the signals to the first substrates and the second substrates of the at least two liquid crystal elements such that the reflective liquid crystal layers of the at least two liquid crystal elements switch between the focal cone state and the reflective state includes: providing signals to a first substrate and a second substrate of the first liquid crystal element such that a reflective liquid crystal layer of the first liquid crystal element is in the focal cone state, providing signals to a first substrate and a second substrate of the second liquid crystal element such that a reflective liquid crystal layer of the second liquid crystal element is in the focal cone state, and the display device displays black; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, and the display device displays the first color; providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, and the display device displays a second color; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, and the display device displays a combined color of the first color and the second color.

In an exemplary implementation mode, the at least two liquid crystal elements include: a first liquid crystal element that reflects light of a first color, a second liquid crystal element that reflects light of a second color, and a third liquid crystal element that reflects light of a third color, and any two of the first color, the second color, and the third color are different; providing the signals to the first substrates and the second substrates of the at least two liquid crystal elements such that the reflective liquid crystal layers of the at least two liquid crystal elements switch between the focal cone state and the reflective state includes: providing signals to a first substrate and a second substrate of the first liquid crystal element such that a reflective liquid crystal layer of the first liquid crystal element is in the focal cone state, providing signals to a first substrate and a second substrate of the second liquid crystal element such that a reflective liquid crystal layer of the second liquid crystal element is in the focal cone state, providing signals to a first substrate and a second substrate of the third liquid crystal element such that a reflective liquid crystal layer of the third liquid crystal element is in the focal cone state, and the display device displays black; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the focal cone state, and the display device displays the first color; providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the focal cone state, and the display device displays the second color; providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the reflective state, and the display device displays the third color; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the focal cone state, and the display device displays a combined color of the first color and the second color; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, providing signals to the first substrate and the second substrate of the third liquid crystal element such that the reflective liquid crystal layer of the third liquid crystal element is in the reflective state, and the display device displays a combined color of the first color and the third color; providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the reflective state, and the display device displays a combined color of the second color and the third color; providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, providing signals to the first substrate and the second substrate of the third liquid crystal element such that the reflective liquid crystal layer of the third liquid crystal element is in the reflective state, and the display device displays a combined color of the first color, the second color and the third color.

In an exemplary implementation mode, the at least two liquid crystal elements include: a first liquid crystal element and a second liquid crystal element, first liquid crystals in the first liquid crystal element and first liquid crystals in the second liquid crystal element are liquid crystals of a first color, second liquid crystals in the first liquid crystal element and second liquid crystals in the second liquid crystal element are liquid crystals of a second color, and the liquid crystals of the first color and the liquid crystals of the second color are liquid crystals of different colors; providing the signals to the first substrates and the second substrates of the at least two liquid crystal elements such that the reflective liquid crystal layers of the at least two liquid crystal elements switch between the focal cone state and the reflective state includes: providing signals to a first substrate and a second substrate of the first liquid crystal element such that the first liquid crystals and the second liquid crystals in a reflective liquid crystal layer of the first liquid crystal element are in the focal cone state, providing signals to a first substrate and a second substrate of the second liquid crystal element such that the first liquid crystals and the second liquid crystals in a reflective liquid crystal layer of the second liquid crystal element are in the focal cone state, and the display device displays black; providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the reflective state and the focal cone state, respectively, and the display device displays the first color; providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the focal cone state and the reflective state, respectively, and the display device displays the second color; providing signals to a first substrate and a second substrate of the first liquid crystal element such that the first liquid crystals and the second liquid crystals in the reflective liquid crystal layer of the first liquid crystal element are in the reflective state, providing signals to a first substrate and a second substrate of the second liquid crystal element such that the first liquid crystals and the second liquid crystals in the reflective liquid crystal layer of the second liquid crystal element are in the reflective state, and the display device displays a combined color of the first color and the second color.

In an exemplary implementation mode, the at least two liquid crystal elements include: a first liquid crystal element, a second liquid crystal element, and a third liquid crystal element, first liquid crystals in the first liquid crystal element and first liquid crystals in the second liquid crystal element are liquid crystals of a first color, second liquid crystals in the first liquid crystal element and first liquid crystals in the third liquid crystal element are liquid crystals of a second color, and second liquid crystals in the second liquid crystal element and second liquid crystals in the third liquid crystal element are liquid crystals of a third color; the driver providing the signals to the first substrates and the second substrates such that the reflective liquid crystal layers switch between the focal cone state and the reflective state includes: providing signals to a first substrate and a second substrate of the first liquid crystal element such that the first liquid crystals and the second liquid crystals in a reflective liquid crystal layer of the first liquid crystal element are in the focal cone state, providing signals to a first substrate and a second substrate of the second liquid crystal element such that the first liquid crystals and the second liquid crystals in a reflective liquid crystal layer of the second liquid crystal element are in the focal cone state, providing signals to a first substrate and a second substrate of the third liquid crystal element such that the first liquid crystals and the second liquid crystals in a reflective liquid crystal layer of the third liquid crystal element are in the focal cone state, and the display device displays black; providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the reflective state and the focal cone state, respectively, providing signals to the first substrate and the second substrate of the third liquid crystal element such that the first liquid crystals and the second liquid crystals in the reflective liquid crystal layer of the third liquid crystal element are in the focal cone state, and the display device displays the first color; providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the focal cone state, providing signals to the first substrate and the second substrate of the third liquid crystal element such that the first liquid crystals and the second liquid crystals in the reflective liquid crystal layer of the third liquid crystal element are in the reflective state and the focal cone state, respectively, and the display device displays the second color; providing signals to the first substrate and the second substrate of the first liquid crystal element such that the first liquid crystals and the second liquid crystals in the reflective liquid crystal layer of the first liquid crystal element are in the focal cone state, providing signals to the first substrate and the second substrate of the second liquid crystal element such that the first liquid crystals and the second liquid crystals in the reflective liquid crystal layer of the second liquid crystal element are in the focal cone state and the reflective state, respectively, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays the third color; providing signals to the first substrate and the second substrate of the first liquid crystal element such that the first liquid crystals and the second liquid crystals in the reflective liquid crystal layer of the first liquid crystal element are in the reflective state, providing signals to the first substrate and the second substrate of the second liquid crystal element such that the first liquid crystals and the second liquid crystals in the reflective liquid crystal layer of the second liquid crystal element are in the reflective state and the focal cone state, respectively, providing signals to the first substrate and the second substrate of the third liquid crystal element such that the first liquid crystals and the second liquid crystals in the reflective liquid crystal layer of the third liquid crystal element are in the reflective state and the focal cone state, respectively, and the display device displays a combined color of the first color and the second color; providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the focal cone state and the reflective state, respectively, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays a combined color of the first color and the third color; providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the reflective state, providing signals to the first substrate and the second substrate of the third liquid crystal element such that the first liquid crystals and the second liquid crystals in the reflective liquid crystal layer of the third liquid crystal element are in the focal cone state and the reflective state, respectively, and the display device displays a combined color of the second color and the third color; providing signals to the first substrate and the second substrate of the first liquid crystal element such that the first liquid crystals and the second liquid crystals in the reflective liquid crystal layer of the first liquid crystal element are in the reflective state, providing signals to the first substrate and the second substrate of the second liquid crystal element such that the first liquid crystals and the second liquid crystals in the reflective liquid crystal layer of the second liquid crystal element are in the reflective state, providing signals to the first substrate and the second substrate of the third liquid crystal element such that the first liquid crystals and the second liquid crystals in the reflective liquid crystal layer of the third liquid crystal element are in the reflective state, and the display device displays a combined color of the first color, the second color and the third color.

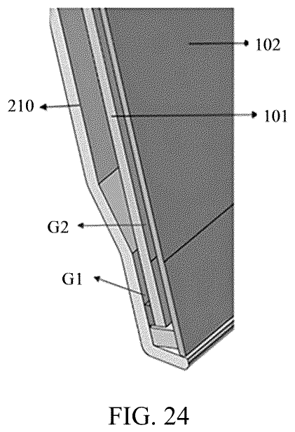

An embodiment of the present disclosure also provides a display apparatus, FIG. 23 is a side view of the display apparatus provided by an embodiment of the present disclosure, and FIG. 24 is an enlarged view of a portion within a dashed box in FIG. 23. As shown in FIGS. 23 and 24, a display apparatus according to an embodiment of the present disclosure may include a display device 100.

The display device is the display device in any one of the foregoing embodiments, implementation principle and implementation effects of which are similar to those of the display device in any one of the foregoing embodiments, and will not be repeated here.

In an exemplary implementation mode, the display device may be a table card or a house card. FIGS. 23 and 24 are illustrated by taking a table card as an example.

In an exemplary implementation mode, as shown in FIGS. 23 and 24, the display apparatus further includes a bracket. The bracket may include a first connection piece 210, a second connection piece 220, and an adapter 230, wherein the adapter 230 is connected with the first connection piece 210 and the second connection piece 220, respectively, the first connection piece 210 and the second connection piece 220 are arranged at an included angle, the display device 100 is fixed on the first connection piece 210, and the first connection piece 210 is located on a backlight side of the display device 100.

In an exemplary implementation mode, as shown in FIGS. 23 and 24, a distance G2 between the backlight side of the display device 100 and the first connection piece 210 ranges from 0.8 mm to 1.2 mm. Exemplarily, the distance G2 between the backlight side of the display device 100 and the first connection piece 210 may be 1 mm. The distance G2 between the backlight side of the display device 100 and the first connection piece 210 ranging from 0.8 mm to 1.2 mm can avoid an Mura defect caused by mutual pressing between the backlight side of the display device and the bracket.

G1 in FIG. 23 refers to a distance between a liquid crystal element layer 101 and a protective cover plate 102 in the display device.

In an exemplary implementation mode, as shown in FIG. 24, the display apparatus may further include a power supply device 240 and a driver device disposed between the first connection piece 210 and the second connection piece 220, wherein the power supply device 240 is electrically connected with the display device 100 and the driver device, respectively, and the driver device is electrically connected with drivers in all the liquid crystal elements in the display device 100.

In an exemplary implementation mode, the display apparatus may further include a power supply cover plate. Herein, the power supply cover plate 250 is configured to protect the power supply device 240.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” the another element, or there may be an intermediate element.

Although implementations of the present disclosure are disclosed above, contents described are only implementations used for ease of understanding of the present disclosure, but not intended to limit the present disclosure. Any of those skilled in the art of the present disclosure can make any modifications and variations in the implementation and details without departing from the spirit and scope of the present disclosure. However, the protection scope of the present disclosure should be subject to the scope defined by the appended claims.

1. A display device comprising: a light absorption layer and a liquid crystal element layer disposed on the light absorption layer, the liquid crystal element layer comprising:
at least two liquid crystal elements stacked, wherein a liquid crystal element of the at least two liquid crystal elements comprises: a first substrate, a reflective liquid crystal layer, and a second substrate, wherein the first substrate is located on a side of the reflective liquid crystal layer close to the light absorption layer, and the second substrate is located on a side of the reflective liquid crystal layer away from the light absorption layer;
operation states of the reflective liquid crystal layer comprise: a reflective state and a focal cone state; and
one liquid crystal element of adjacent liquid crystal elements has the reflective liquid crystal layer in the reflective state, with a light reflected by the one liquid crystal element comprising at least a left-handed polarized light; other liquid crystal element of the adjacent liquid crystal elements has the reflective liquid crystal layer in the reflective state, with a light reflected by the other liquid crystal element comprising at least a right-handed polarized light.

2. The display device according to claim 1, wherein
the first substrate comprises: a first base and a first electrode layer, the second substrate comprises: a second base and a second electrode layer, the first electrode layer is located on a side of the first base close to the reflective liquid crystal layer, the second electrode layer is located on a side of the second base close to the reflective liquid crystal layer, and the first base comprises: a data signal line and a scan signal line;
the data signal line and the scan signal line intersect to define a plurality of sub-pixels, the first electrode layer comprises first electrodes arranged in an array, the second electrode layer comprises second electrodes, the reflective liquid crystal layer comprises liquid crystals, a sub-pixel of the plurality of sub-pixels comprises a first electrode, a liquid crystal, and a second electrode, and the first electrode and the second electrode are transparent electrodes;
an orthographic projection of the first electrode on the first base is at least partially overlapped with an orthographic projection of the second electrode on the first base.

3. The display device according to claim 2, wherein a wavelength L of a light reflected by the liquid crystal in the reflective liquid crystal layer and a distance P between the first electrode and the second electrode of the sub-pixel where the liquid crystal is located satisfy a formula: L=n*t*P, wherein n is an average refractive index of the liquid crystal, and t is a ratio of a pitch of the liquid crystal to a distance between a first electrode and a second electrode of any sub-pixel in the liquid crystal element.

4. The display device according to claim 3, wherein the liquid crystal element reflects light of one color, the liquid crystals are either left-handed cholesteric phase liquid crystals or right-handed cholesteric phase liquid crystals, the liquid crystals are the left-handed cholesteric phase liquid crystals when the liquid crystal element reflects a left-handed polarized light, and the liquid crystals are the right-handed cholesteric phase liquid crystals when the liquid crystal element reflects right-handed polarized light;
the liquid crystals of all sub-pixels are the same, a surface of the first base close to the reflective liquid crystal layer is flat, and a distance between a first electrode and a second electrode for any two sub-pixels of all sub-pixels is equal.

5. The display device according to claim 3, wherein the liquid crystal element reflects light of two colors, the liquid crystals comprise first liquid crystals and second liquid crystals, the first liquid crystals and the second liquid crystals are either left-handed cholesteric phase liquid crystals or right-handed cholesteric phase liquid crystals, and the first liquid crystals and the second liquid crystals are configured to reflect light of different wavelengths;
the plurality of sub-pixels in the liquid crystal element are arrayed in a first direction and a second direction, the first direction and the second direction intersect; a liquid crystal of one sub-pixel of two sub-pixels arranged in the first direction is a first liquid crystal, a liquid crystal of the other sub-pixel of the two sub-pixels arranged in the first direction is a second liquid crystal, a liquid crystal of one sub-pixel of two sub-pixels arranged in the second direction is a first liquid crystal, and a liquid crystal of the other sub-pixel of the two sub-pixels arranged in the second direction is a second liquid crystal;
a surface of the first base close to the reflective liquid crystal layer is not flat, and a distance between a first electrode and a second electrode of a sub-pixel where a first liquid crystal is located is not equal to a distance between a first electrode and a second electrode of a sub-pixel where a second liquid crystal is located;
when the liquid crystal element reflects the left-handed polarized light, the first liquid crystals and the second liquid crystals are the left-handed cholesteric phase liquid crystals, when the liquid crystal element reflects the right-handed polarized light, the first liquid crystals and the second liquid crystals are the right-handed cholesteric phase liquid crystals, and when the liquid crystal element reflects the left-handed polarized light and the right-handed polarized light, either the first liquid crystals or the second liquid crystals are the left-handed cholesteric phase liquid crystals, and the others of the first liquid crystals and the second liquid crystals are the right-handed cholesteric phase liquid crystals.

6. The display device according to claim 4, wherein the at least two liquid crystal elements comprise: a first liquid crystal element and a second liquid crystal element;
the first liquid crystal element has the reflective liquid crystal layer in the reflective state, with the first liquid crystal element reflecting light of a first color; the second liquid crystal element has the reflective liquid crystal layer in the reflective state, with the second liquid crystal element reflecting light of a second color;
wherein the first color and the second color are different, a combined color of the first color and the second color is white, in a state in which a wavelength of the first color is larger than a wavelength of the second color, and a distance between a first electrode and a second electrode of any sub-pixel in the first liquid crystal element is larger than a distance between a first electrode and a second electrode of any sub-pixel in the second liquid crystal element; or
the first color and the second color are the same, and the distance between the first electrode and the second electrode of any sub-pixel in the first liquid crystal element is the same as the distance between the first electrode and the second electrode of any sub-pixel in the second liquid crystal element.

7-9. (canceled)

10. The display device according to claim 6, wherein the at least two liquid crystal elements further comprise: a third liquid crystal element;
the third liquid crystal element has the reflective liquid crystal layer in the reflective state, with the third liquid crystal element reflecting light of a third color;
the first color, the second color, and the third color are different colors, and a combined color of the first color, the second color, and the third color is white.

11. The display device according to claim 10, wherein any two of a distance between a first electrode and a second electrode of any sub-pixel in the first liquid crystal element, a distance between a first electrode and a second electrode of any sub-pixel in the second liquid crystal element, and a distance between a first electrode and a second electrode of any sub-pixel in the third liquid crystal element are different.

12. (canceled)

13. The display device according to claim 5, wherein the at least two liquid crystal elements comprise: a first liquid crystal element and a second liquid crystal element;
the first liquid crystals in the first liquid crystal element and the first liquid crystals in the second liquid crystal element are liquid crystals of a first color, and the second liquid crystals in the first liquid crystal element and the second liquid crystals in the second liquid crystal element are liquid crystals of a second color;
the first liquid crystals and the second liquid crystals in the first liquid crystal element are left-handed cholesteric phase liquid crystals, the first liquid crystals and the second liquid crystals in the second liquid crystal element are right-handed cholesteric phase liquid crystals; or the first liquid crystals and the second liquid crystals in the first liquid crystal element are the right-handed cholesteric phase liquid crystals, the first liquid crystals and the second liquid crystals in the second liquid crystal element are the left-handed cholesteric phase liquid crystals; or the first liquid crystals in the first liquid crystal element are the left-handed cholesteric phase liquid crystals, the second liquid crystals in the first liquid crystal element are the right-handed cholesteric phase liquid crystals, the first liquid crystals in the second liquid crystal element are the right-handed cholesteric phase liquid crystals, the second liquid crystals in the second liquid crystal element are the left-handed cholesteric phase liquid crystals, or the first liquid crystals in the first liquid crystal element are the right-handed cholesteric phase liquid crystals, the second liquid crystals in the first liquid crystal element are the left-handed cholesteric phase liquid crystals, the first liquid crystals in the second liquid crystal element are the left-handed cholesteric phase liquid crystals, the second liquid crystals in the second liquid crystal element are the right-handed cholesteric phase liquid crystals;
the liquid crystals of the first color and the liquid crystals of the second color are liquid crystals of different colors, and a combined color of a color of light reflected by the liquid crystals of the first color and a color of light reflected by the liquid crystals of the second color is white.

14. The display device according to claim 13, wherein a distance between a first electrode and a second electrode of a sub-pixel where a first liquid crystal in the first liquid crystal element is located is the same as a distance between a first electrode and a second electrode of a sub-pixel where a first liquid crystal in the second liquid crystal element is located;
a distance between a first electrode and a second electrode of a sub-pixel where a second liquid crystal in the first liquid crystal element is located is the same as a distance between a first electrode and a second electrode of a sub-pixel where a second liquid crystal in the second liquid crystal element is located.

15. The display device according to claim 13, wherein when the liquid crystals of the first color and the liquid crystals of the second color are either red cholesteric phase liquid crystals or cyan cholesteric phase liquid crystals, a distance between a first electrode and a second electrode of a sub-pixel where a liquid crystal reflecting a red light is located is greater than a distance between a first electrode and a second electrode of a sub-pixel where a liquid crystal reflecting a cyan light is located;
when the liquid crystals of the first color and the liquid crystals of the second color are either yellow cholesteric phase liquid crystals or blue cholesteric phase liquid crystals, a distance between a first electrode and a second electrode of a sub-pixel where a liquid crystal reflecting a yellow light is located is greater than a distance between a first electrode and a second electrode of a sub-pixel where a liquid crystal reflecting a blue light is located.

16. The display device according to claim 15, wherein an orthographic projection of a sub-pixel comprising a first liquid crystal in the first liquid crystal element on the light absorption layer is at least partially overlapped with an orthographic projection of a sub-pixel comprising a first liquid crystal in the second liquid crystal element on the light absorption layer, and the orthographic projection of the sub-pixel comprising the first liquid crystal in the first liquid crystal element on the light absorption layer is not overlapped with an orthographic projection of a sub-pixel comprising a second liquid crystal in the second liquid crystal element on the light absorption layer;
an orthographic projection of a sub-pixel comprising a second liquid crystal in the first liquid crystal element on the light absorption layer is at least partially overlapped with the orthographic projection of the sub-pixel comprising the second liquid crystal in the second liquid crystal element on the light absorption layer, and the orthographic projection of the sub-pixel comprising the second liquid crystal in the first liquid crystal element on the light absorption layer is not overlapped with the orthographic projection of the sub-pixel comprising the first liquid crystal in the second liquid crystal element on the light absorption layer.

17. The display device according to claim 5, wherein the at least two liquid crystal elements comprise: a first liquid crystal element, a second liquid crystal element, and a third liquid crystal element;
the first liquid crystals in the first liquid crystal element and the first liquid crystals in the second liquid crystal element are liquid crystals of a first color, the second liquid crystals in the first liquid crystal element and the first liquid crystals in the third liquid crystal element are liquid crystals of a second color, and the second liquid crystals in the second liquid crystal element and the second liquid crystals in the third liquid crystal element are liquid crystals of a third color;
either the first liquid crystals in the first liquid crystal element or the first liquid crystals in the second liquid crystal element are left-handed cholesteric phase liquid crystals, the others of the first liquid crystals in the first liquid crystal element and the first liquid crystals in the second liquid crystal element are right-handed cholesteric phase liquid crystals, either the second liquid crystals in the first liquid crystal element or the first liquid crystals in the third liquid crystal element are the left-handed cholesteric phase liquid crystals, either the second liquid crystals in the first liquid crystal element or the first liquid crystals in the third liquid crystal element are the right-handed cholesteric phase liquid crystal, either the second liquid crystals in the second liquid crystal element or the second liquid crystals in the third liquid crystal element are the left-handed cholesteric phase liquid crystals, the others of the second liquid crystals in the second liquid crystal element and the second liquid crystals in the third liquid crystal element are the right-handed cholesteric phase liquid crystals, the first liquid crystals and the second liquid crystals in the first liquid crystal element are the left-handed cholesteric phase liquid crystals or the right-handed cholesteric phase liquid crystals, either the first liquid crystals or the second liquid crystals in the second liquid crystal element are the left-handed cholesteric phase liquid crystals, the others of the first liquid crystals and the second liquid crystals in the second liquid crystal element are the right-handed cholesteric phase liquid crystals, and the first liquid crystals and the second liquid crystals in the third liquid crystal element are the left-handed cholesteric phase liquid crystals or the right-handed cholesteric phase liquid crystals;
the liquid crystals of the first color, the liquid crystals of the second color, and the liquid crystals of the third color are liquid crystals of different colors, and a combined color of light reflected by the liquid crystals of the first color, light reflected by the liquid crystals of the second color, and light reflected by the liquid crystals of the third color is white.

18. The display device according to claim 17, wherein a distance between a first electrode and a second electrode of a sub-pixel where a first liquid crystal in the first liquid crystal element is located is the same as a distance between a first electrode and a second electrode of a sub-pixel where a first liquid crystal in the second liquid crystal element is located;
a distance between a first electrode and a second electrode of a sub-pixel where a second liquid crystal in the first liquid crystal element is located is the same as a distance between a first electrode and a second electrode of a sub-pixel where a first liquid crystal in the third liquid crystal element is located;
a distance between a first electrode and a second electrode of a sub-pixel where a second liquid crystal in the second liquid crystal element is located is the same as a distance between a first electrode and a second electrode of a sub-pixel where a second liquid crystal in the third liquid crystal element is located.

19. The display device according to claim 18, wherein the liquid crystals of the first color, the liquid crystals of the second color, and the liquid crystals of the third color are one of red cholesteric phase liquid crystals, green cholesteric phase liquid crystals, and blue cholesteric phase liquid crystals;
a distance between a first electrode and a second electrode of a sub-pixel where a red cholesteric phase liquid crystal is located is greater than a distance between a first electrode and a second electrode of a sub-pixel where a green cholesteric phase liquid crystal is located, and the distance between the first electrode and the second electrode of the sub-pixel where the green cholesteric phase liquid crystal is located is greater than a distance between a first electrode and a second electrode of a sub-pixel where a blue cholesteric phase liquid crystal is located.

20. The display device according to claim 19, wherein the distance between the first electrode and the second electrode of the sub-pixel where the red cholesteric phase liquid crystal is located ranges from 5.8 microns to 6.2 microns;
the distance between the first electrode and the second electrode of the sub-pixel where the green cholesteric phase liquid crystal is located ranges from 4.8 microns to 5.2 microns;
the distance between the first electrode and the second electrode of the sub-pixel where the blue cholesteric phase liquid crystal is located ranges from 3.8 microns to 4.2 microns.

21-26. (canceled)

27. The display device according to claim 2, wherein the second base comprises:
a black matrix layer, and an orthographic projection of the black matrix layer on the first base is at least partially overlapped with orthographic projections of the data signal line and the scan signal line on the first base;
the black matrix layer comprises: a first black matrix structure and a second black matrix structure, an orthographic projection of the first black matrix structure on the light absorption layer is at least partially overlapped with an orthographic projection of the data signal line on the light absorption layer, an orthographic projection of the second black matrix structure on the light absorption layer is at least partially overlapped with an orthographic projection of the scan signal line on the light absorption layer;
a distance between the orthographic projection of the first black matrix structure on the light absorption layer and an orthographic projection of a first electrode of any one of two adjacent sub-pixels located on both sides of the data signal line on the light absorption layer is a first distance, a distance between the orthographic projection of the second black matrix structure on the light absorption layer and an orthographic projection of a first electrode of any one of two adjacent sub-pixels located on both sides of the scan signal line on the light absorption layer is a second distance, and the first distance is larger than the second distance;
a distance between an orthographic projection of a boundary of the data signal line close to one of the two adjacent sub-pixels located on both sides of the data signal line on the light absorption layer and an orthographic projection of a boundary of the first black matrix structure close to the other of the two adjacent sub-pixels located on both sides of the data signal line on the light absorption layer is larger than a bonding deviation of adjacent liquid crystal elements;
a distance between an orthographic projection of a boundary of the scan signal line close to one of the two adjacent sub-pixels located on both sides of the scan signal line on the light absorption layer and an orthographic projection of a boundary of the second black matrix structure close to the other of the two adjacent sub-pixels located on both sides of the scan signal line on the light absorption layer is larger than the bonding deviation of the adjacent liquid crystal elements.

28-30. (canceled)

31. A driving method of a display device, configured for driving the display device according to claim 1, the method comprising:
providing signals to first substrates and second substrates of at least two liquid crystal elements such that reflective liquid crystal layers of the at least two liquid crystal elements switch between the focal cone state and the reflective state.

32. The method according to claim 31, wherein the at least two liquid crystal elements comprise a first liquid crystal element that reflects light of a first color and a second liquid crystal element that reflects light of a second color, and the first color and the second color are different;
providing the signals to the first substrates and the second substrates of the at least two liquid crystal elements such that the reflective liquid crystal layers of the at least two liquid crystal elements switch between the focal cone state and the reflective state comprises:
providing signals to a first substrate and a second substrate of the first liquid crystal element such that a reflective liquid crystal layer of the first liquid crystal element is in the focal cone state, providing signals to a first substrate and a second substrate of the second liquid crystal element such that a reflective liquid crystal layer of the second liquid crystal element is in the focal cone state, and the display device displays black;
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the focal cone state, and the display device displays the first color;
providing signals to the first substrate and the second substrate of the first liquid crystal element such that the reflective liquid crystal layer of the first liquid crystal element is in the focal cone state, providing signals to the first substrate and the second substrate of the second liquid crystal element such that the reflective liquid crystal layer of the second liquid crystal element is in the reflective state, and the display device displays a second color; and
providing signals to the first substrate and the second substrate of the first liquid crystal element such that the reflective liquid crystal layer of the first liquid crystal element is in the reflective state, providing signals to the first substrate and the second substrate of the second liquid crystal element such that the reflective liquid crystal layer of the second liquid crystal element is in the reflective state, and the display device displays a combined color of the first color and the second color.

33. (canceled)

34. The method according to claim 31, wherein the at least two liquid crystal elements comprise: a first liquid crystal element and a second liquid crystal element, first liquid crystals in the first liquid crystal element and first liquid crystals in the second liquid crystal element are liquid crystals of a first color, second liquid crystals in the first liquid crystal element and second liquid crystals in the second liquid crystal element are liquid crystals of a second color, and the liquid crystals of the first color and the liquid crystals of the second color are liquid crystals of different colors;
providing the signals to the first substrates and the second substrates of the at least two liquid crystal elements such that the reflective liquid crystal layers of the at least two liquid crystal elements switch between the focal cone state and the reflective state comprises:
providing signals to a first substrate and a second substrate of the first liquid crystal element such that the first liquid crystals and the second liquid crystals in a reflective liquid crystal layer of the first liquid crystal element are in the focal cone state, providing signals to a first substrate and a second substrate of the second liquid crystal element such that the first liquid crystals and the second liquid crystals in a reflective liquid crystal layer of the second liquid crystal element are in the focal cone state, and the display device displays black;
providing signals to the first substrate and the second substrate of the first liquid crystal element such that the first liquid crystals and the second liquid crystals in the reflective liquid crystal layer of the first liquid crystal element are in the reflective state and the focal cone state, respectively, providing signals to the first substrate and the second substrate of the second liquid crystal element such that the first liquid crystals and the second liquid crystals in the reflective liquid crystal layer of the second liquid crystal element are in the reflective state and the focal cone state, respectively, and the display device displays the first color;
providing signals to the first substrate and the second substrate of the first liquid crystal element such that the first liquid crystals and the second liquid crystals in the reflective liquid crystal layer of the first liquid crystal element are in the focal cone state and the reflective state, respectively, providing signals to the first substrate and the second substrate of the second liquid crystal element such that the first liquid crystals and the second liquid crystals in the reflective liquid crystal layer of the second liquid crystal element are in the focal cone state and the reflective state, respectively, and the display device displays the second color;
providing signals to a first substrate and a second substrate of the first liquid crystal element such that the first liquid crystals and the second liquid crystals in the reflective liquid crystal layer of the first liquid crystal element are in the reflective state, providing signals to a first substrate and a second substrate of the second liquid crystal element such that the first liquid crystals and the second liquid crystals in the reflective liquid crystal layer of the second liquid crystal element are in the reflective state, and the display device displays a combined color of the first color and the second color.

35. (canceled)
